(19) United States
(12) Patent Application Publication
(10) Pub. No.: US 2025/0077969 A1
(43) Pub. Date: Mar. 6, 2025

(54) INTERACTIVE USER EXPERIENCE FOR GENERATING BALANCED CLASSIFIERS

(71) Applicant: FAIR ISAAC CORPORATION, Minneapolis, MN (US)

(72) Inventor: Gerald Fahner, Austin, TX (US)

(21) Appl. No.: 18/784,747

(22) Filed: Jul. 25, 2024

Related U.S. Application Data
(60) Provisional application No. 63/579,450, filed on Aug. 29, 2023.

(51) Int. Cl. G06N 20/00

(52) U.S. Cl. CPC G06N 20/00

(57) ABSTRACT

A computer-implemented method for generating a classifier, comprising: processing a training data set, wherein the training data set comprises a plurality of training examples, and wherein each of the plurality of training examples is associated with multiple class labels; training a set of candidate classifiers, wherein random weights are assigned to multiple training objectives for training the set of candidate classifiers, and wherein the multiple training objectives corresponds to the multiple class labels; assessing each classifier of the set of candidate classifiers to generate multiple performance measurements for each of the set of candidate classifiers, wherein each of the multiple performance measurements is associated with each of the multiple training objectives, respectively; generating a tradeoff table presenting performances of each classifier of the set of candidate classifiers, based at least in part on the multiple performance measurements.

### CROSS REFERENCE

This application claims priority to U.S. Patent Application No. 63/579,450, filed Aug. 29, 2023, the contents of which are fully incorporated by reference.

### TECHNICAL FIELD

The subject matter described herein relates to systems and methods for using Machine Learning (ML) technique to make predictions, for example generating an omnibus balanced classifier for multiple uses.

### BACKGROUND

In recent years, Machine Learning (ML) models have gained widespread adoption across various industries for predictive purposes. For instance, in the retail sector, predictive models are utilized to forecast customer demand, optimize inventory levels, and personalize marketing campaigns, ultimately resulting in increased sales and improved customer satisfaction. In healthcare, predictive models play a crucial role in patient diagnosis, treatment recommendations, and disease outbreak predictions, contributing to enhanced patient care and proactive healthcare management. Furthermore, within the financial industry, ML models are employed for credit risk assessment, fraud detection, and market trend predictions, thereby enhancing decision-making processes and mitigating potential risks. These examples illustrate the substantial impact of predictive ML models, transforming industries and driving data-driven decision-making across diverse sectors.

### SUMMARY

Methods, systems, and articles of manufacture, including computer program products, are provided for generating ML classifier for data owners. In one aspect, there is provided a system. The system may include at least one processor and at least one memory. The at least one memory may store instructions that result in operations when executed by the at least one processor. The operations may include: processing a training data set, wherein the training data set comprises a plurality of training examples, and wherein each of the plurality of training examples is associated with multiple class labels; training a set of candidate classifiers, wherein random weights are assigned to multiple training objectives for training the set of candidate classifiers, and wherein the multiple training objectives corresponds to the multiple class labels; assessing each classifier of the set of candidate classifiers to generate multiple performance measures for each of the set of candidate classifiers and their associated scores, wherein each of the multiple performance measurements is associated with each of the multiple training objectives, respectively; generating a tradeoff table presenting performances of each classifier of the set of candidate classifiers, based at least in part on the multiple performance measurements; and providing a visualization of the tradeoff table with dynamic interactive user experience to illustrate corresponding performances across different corresponding objectives of the multiple training objectives, wherein the dynamic interactive user experience allows a user to adjust a level of focus on a first set of the multiple training objectives.

In another aspect, there is provided a method. The method includes: processing, by at least one processor, a training data set, wherein the training data set comprises a plurality of training examples, and wherein each of the plurality of training examples is associated with multiple class labels; training, by the at least one processor, a set of candidate classifiers, wherein random weights are assigned to multiple training objectives for training the set of candidate classifiers, and wherein the multiple training objectives corresponds to the multiple class labels; assessing, by the at least one processor, each classifier of the set of candidate classifiers to generate multiple performance measures for each of the set of candidate classifiers and their associated scores, wherein each of the multiple performance measurements is associated with each of the multiple training objectives, respectively; generating, by the at least one processor, a tradeoff table presenting performances of each classifier of the set of candidate classifiers, based at least in part on the multiple performance measurements; and providing, by the at least one processor via a display, a visualization of the tradeoff table with dynamic interactive user experience to illustrate corresponding performances across different corresponding objectives of the multiple training objectives, wherein the dynamic interactive user experience allows a user to adjust a level of focus on a first set of the multiple training objectives.

In another aspect, there is provided a computer program product including a non-transitory computer readable medium storing instructions. The operations include processing a training data set, wherein the training data set comprises a plurality of training examples, and wherein each of the plurality of training examples is associated with multiple class labels; training a set of candidate classifiers, wherein random weights are assigned to multiple training objectives for training the set of candidate classifiers, and wherein the multiple training objectives corresponds to the multiple class labels; assessing each classifier of the set of candidate classifiers to generate multiple performance measures for each of the set of candidate classifiers and their associated scores, wherein each of the multiple performance measurements is associated with each of the multiple training objectives, respectively; generating a tradeoff table presenting performances of each classifier of the set of candidate classifiers, based at least in part on the multiple performance measurements; and providing a visualization of the tradeoff table with dynamic interactive user experience to illustrate corresponding performances across different corresponding objectives of the multiple training objectives, wherein the dynamic interactive user experience allows a user to adjust a level of focus on a first set of the multiple training objectives.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is block diagram depicting an example system, according to one or more implementations of the current subject matter, comprising a client-server architecture and network configured to perform the various methods described herein;

FIG. 2 is a diagram illustrating the performance tradeoffs of ten classifiers within the context of two objectives, according to one or more implementations of the current subject matter;

FIG. 3 is a diagram illustrating the performance tradeoffs of one thousand classifiers within the context of three objectives, according to one or more implementations of the current subject matter;

FIG. 4 is a diagram illustrating the performance tradeoffs of five classifiers within the context of two objectives, according to one or more implementations of the current subject matter;

FIG. 5 is a flow diagram depicting an example process for delivering interactive user experience, according to one or more implementations of the current subject matter;

FIG. 6A illustrates class labels y1, . . . , yM associated with the alternative class definitions to the development data (e.g., training data set), according to one or more implementations of the current subject matter;

FIG. 6B illustrates class labels y1, . . . , yM associated with the alternative class definitions to the development data (e.g., training data set) with an additional column of group information, according to one or more implementations of the current subject matter;

FIG. 6C illustrates class labels y1, . . . , yM associated with the alternative class definitions to the development data (e.g., training data set) with multiple additional columns of group information, according to one or more implementations of the current subject matter;

FIG. 7 illustrates assessment data set associated with alternative class definitions, according to one or more implementations of the current subject matter;

FIG. 8 illustrates an exemplary implementations of a tradeoff table where performance of a set of N=12 classifiers is evaluated on M=2 class definitions, according to one or more implementations of the current subject matter;

FIG. 9-11 illustrates an exemplary graphical user interface (GUI)-based visualization designed to facilitate the interactive elicitation of the decision maker's favored classifier from the pool of candidate classifiers, according to one or more implementations of the current subject matter;

FIG. 12 depicts a block diagram illustrating an example of a computing system, consistent with implementations of the current subject matter;

FIG. 13 depicts a chart illustrating the impact of one feature to the outcome of the classifiers, consistent with implementations of the current subject matter;

FIG. 14 depicts a chart illustrating the modified impact of one feature to the outcome of the classifiers, consistent with implementations of the current subject matter;

FIG. 15 depicts a chart illustrating an example of score distribution differences between groups, consistent with implementations of the current subject matter;

FIG. 16 depicts a chart illustrating an example of score distribution differences between groups after trained under fairness objective, consistent with implementations of the current subject matter;

FIG. 17 depicts a chart illustrating an example of score distribution differences between groups after trained under fairness objective, consistent with implementations of the current subject matter;

FIG. 18 illustrates an exemplary implementations of a tradeoff table where performances of a set of N=1,000,000 classifiers are evaluated across various objectives, according to one or more implementations of the current subject matter

When practical, like labels are used to refer to same or similar items in the drawings.

### DETAILED DESCRIPTION

The details of one or more variations of the subject matter described herein are set forth in the accompanying drawings. While various implementations of the current subject matter have been shown and described herein, it will be obvious to those skilled in the art that such implementation are provided by way of example only. Numerous variations, changes, and substitutions may occur to those skilled in the art without departing from the current subject matter. It should be understood that various alternatives to the implementations of the current subject matter described herein may be employed.

As discussed herein elsewhere, machine learning (ML) models are becoming increasingly widespread in producing predictions for diverse business or scientific applications. Often times, tailored classifiers or models are developed to serve specific individual purposes, leading to separate classifiers being trained for different use cases. Nonetheless, employing a comprehensive model that encompasses multiple applications offers various advantages in terms of simplicity for customers and potential cost savings. Accordingly, provided herein are platform, systems and methods that provide expeditious training, iterative refinement, and effective assessment of candidate ML models/classifiers to suit multiple applications. Additionally, the disclosed technology introduces an additional objective in the training process that mitigates the risk of over-reliance on any single feature, which could lead to model manipulation or reduced performance due to future data drift. By incorporating terms in the objective function that control the influence of individual features, the technology ensures that no single feature disproportionately affects the model's predictions, thereby enhancing the robustness and generalizability of the model across various applications. Moreover, the technology addresses concerns of fairness by including objectives that promote group fairness, ensuring that the model's predictions do not inadvertently disadvantage or favor any particular demographic group. This is particularly pertinent in applications where equitable outcomes across different groups are desired or legally mandated. By training the model to consider group fairness, the technology aids in producing classifiers that are not just accurate, but also fair and unbiased. Additionally or alternatively, it provides mechanisms for interactive visualization and may graphically illustrate results, catering to the user-friendly and intuitive presentations for decision makers to facilitate their selection of the classifier that balances performance between the multiple objectives for the multiple applications. This approach may streamline the model development process and also provide a safeguard against potential gaming of the system by users aware of the model's feature dependencies, ensuring fairer and more consistent and more robust outcomes.

As discussed herein elsewhere, the platform, systems, and methods presented herein may offer numerous advantages. It may expedite model training, generate tradeoff tables swiftly, and provide visualizations to aid the subsequent actions of decision makers. Additionally or alternatively, it may reduce the computational burden by providing the training and assessment methodology as described herein elsewhere in more detail.

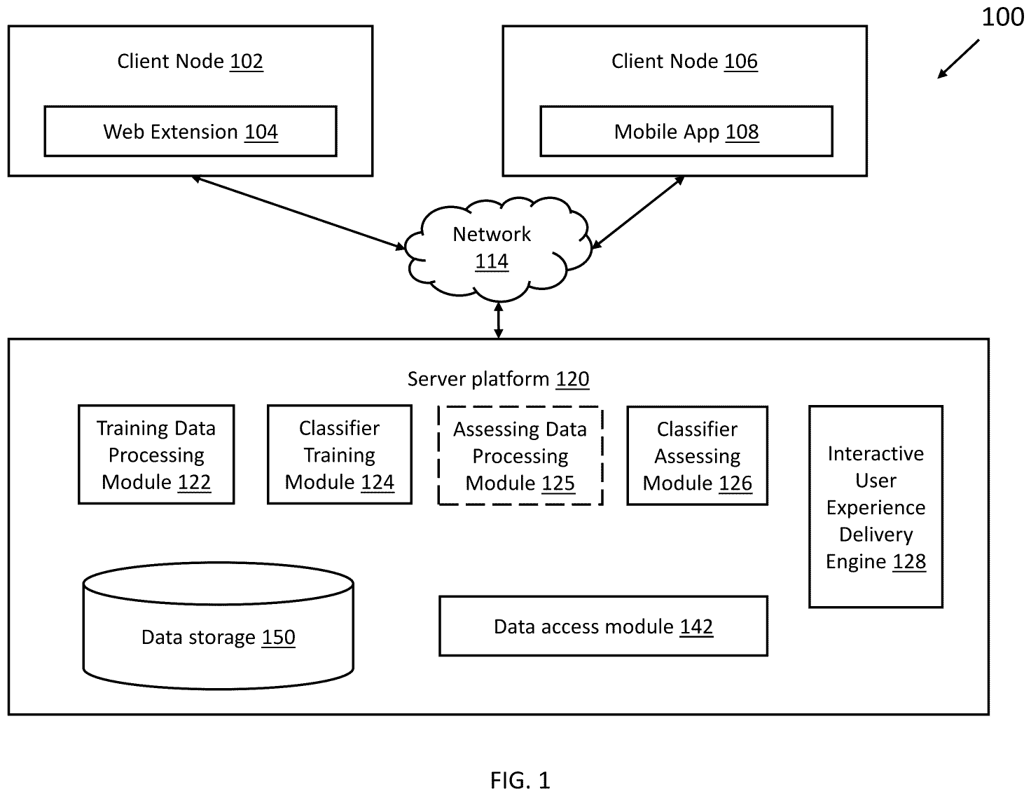

FIG. 1 is a block diagram depicting an example system 100 comprising a client-server architecture and network configured to perform the various methods described herein. A platform (e.g., machines and software, possibly interoperating via a series of network connections, protocols, application-level interfaces, and so on), in the form of a server platform 120, provides server-side functionality via a communication network 114 (e.g., the Internet or other types of wide-area networks (WANs), such as wireless networks or private networks with additional security appropriate to tasks performed by a user) to one or more client nodes 102, and/or 106.

As described herein elsewhere, current advancements in the development of interpretable classifiers primarily focus on a single classification performance objective associated with a specific class definition. The systems and methods provided herein address the significant challenge of generating an interpretable classifier that attains a desired performance balance across multiple performance objectives. Each of these performance objectives corresponds to an alternative class definition that holds practical significance (e.g., for a particular use).

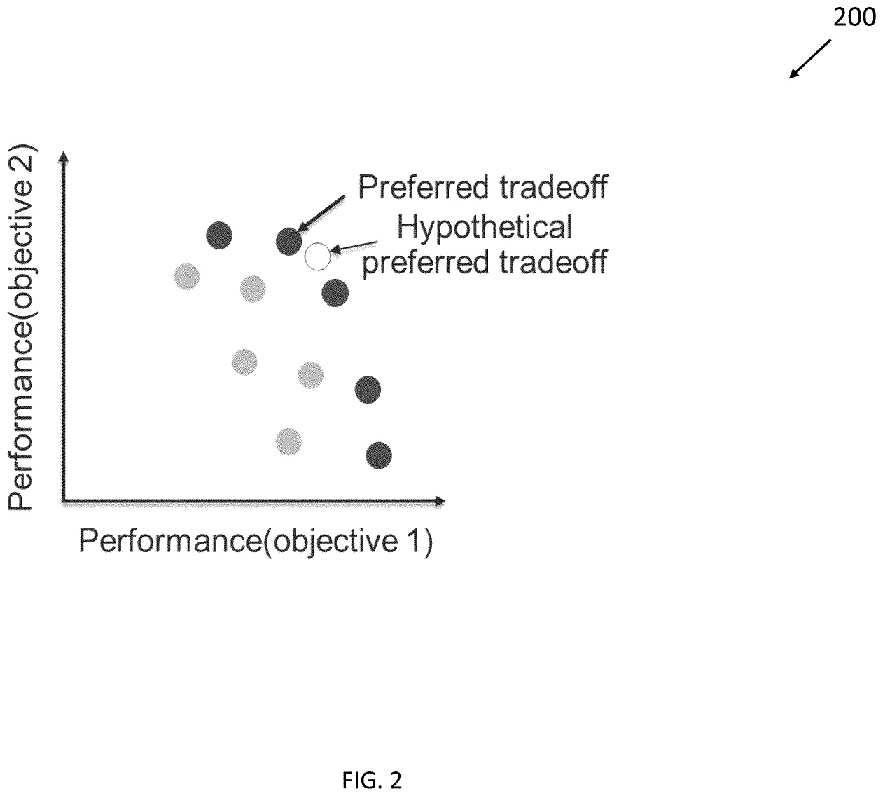

The server platform 120 may generate and present tradeoffs that manifest when a set of candidate classifiers are evaluated against multiple performance objectives. The graphical representation in FIG. 2 illustrates the performance tradeoffs of ten classifiers within the context of two objectives. As shown in FIG. 2, the solid filled dots in the figure symbolize the performance (with higher values indicating better performance) of ten potential classifiers across two distinct performance objectives. The darker solid dots represent classifiers that outperform the lighter solid dots, meaning for every lighter dot, there exists a corresponding darker dot that surpasses it in both objectives. Consequently, the decision maker's attention is directed towards the darker solid dots, known as Pareto-optimal solutions, situated along the Pareto frontier. For example, a decision maker who prioritizes performance objective 2 and to a lesser extent, objective 1, might opt for the candidate classifier labeled as ‘Preferred tradeoff’. This particular classifier performs nearly as well as the best classifier on objective 2 while still maintaining an acceptable performance on objective 1. The unfilled circle located near the ‘Preferred tradeoff’ designates a hypothetical classifier on the Pareto frontier. It indicates that, although not part of the candidate classifier set, this hypothetical classifier would have been favored if included. This underscores the importance of generating an ample number of candidate classifiers to comprehensively cover the Pareto frontier, which may ensure the presence of a candidate classifier that is in close vicinity to any hypothetical preferred tradeoff.

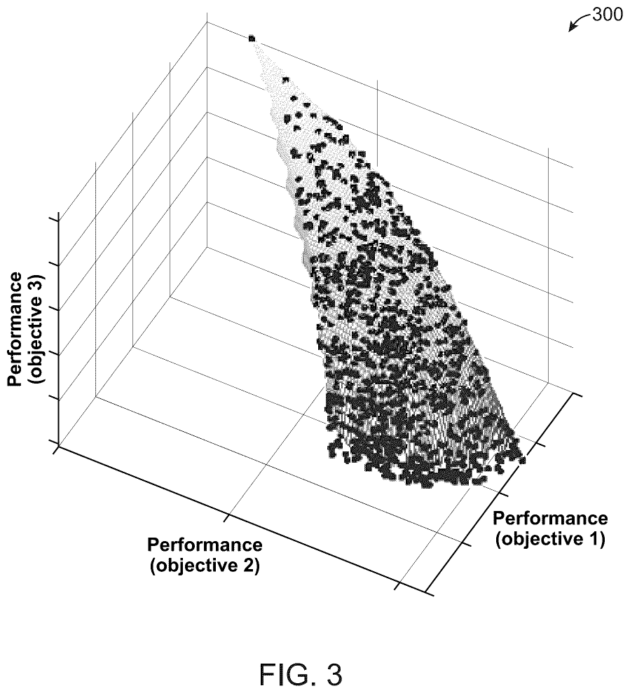

In some implementations, if there are more than two objectives that trade off against each other, it may require many more candidate classifiers to be trained to cover the resulting higher-dimensional Pareto surface. FIG. 3 illustrates the performance tradeoffs of one thousand classifiers within the context of three objectives. As such, the number of candidates scales exponentially with the number of objectives. As shown in FIG. 3, a densely covered Pareto frontier relating to 3 performance objectives is illustrated. The tradeoffs in performance across 1000 candidate classifiers are represented by the darker solid dots. The lighter solid dots in FIG. 3 are presented solely for illustration for the inferior classifiers (i.e., the classifiers that do not make to the Pareto-optimal surface). As discussed in further details, the systems and methods provided herein do not generate inferior classifiers. As the number of performance objectives increases, the task of a decision maker to discern the preferences, develop an understanding of tradeoffs, and ultimately make an informed selection from the myriad candidates becomes more intricate. To address these challenges, the server platform 120 may train a sufficiently large set of candidate classifiers, and generate and/or present performance tradeoffs to one or more users (i.e., decision makers) where the sufficiently large set of candidate classifiers are evaluated against multiple performance objectives in an intuitive manner.

Referring back to FIG. 1, which illustrates, for example, a client node 102 hosting a web extension 104, thus allowing a user to access functions provided by the server platform 120, for example, receiving a visualization of an interactive user experience from the server platform 120. The web extension 104 may be compatible with any web browser application used by a user of the client node. Further, FIG. 1 illustrates, for example, another client node 106 hosting a mobile application 108, thus allowing a user to access functions provide by the server platform 120, for example, receiving a visualization of an interactive user experience from the server platform 120. Delivery may be through a wired or wireless mode of communication.

The interactive user experience may include, without limitation, data content in a format that is intended to solicit user response or a format that is intended to elicit user activity or response. Examples of interactive user experience include, without limitation, dynamic visualizations wherein correlated adjustments in response to one or more user inputs may be automatically presented to a user. Further elaboration on the interactive user experience and/or dynamic visualizations is provided herein elsewhere with greater depth.

A client node (e.g., client node 102 and/or client node 106) may be, for example, a user device (e.g., mobile electronic device, stationary electronic device, etc.). A client node may be associated with, and/or be accessible to, a user. In another example, a client node may be a computing device (e.g., server) accessible to, and/or associated with, an individual or entity. A node may comprise a network module (e.g., network adaptor) configured to transmit and/or receive data. Via the nodes in the computer network, multiple users and/or servers may communicate and exchange data, such as interactive user experience.

In at least some examples, the server platform 120 may be one or more computing devices or systems, storage devices, and other components that include, or facilitate the operation of, various execution modules depicted in FIG. 1. These modules may include, for example, a training data processing module 122, a classifier training module 124, an optional assessing data processing module 125, a classifier assessing module 126, an interactive user experience delivery engine 128, a data access module 142, and a data storage 150. Each of these modules is described in greater detail below.

The training data processing module 122 may receive and process training data set. The training data set, in some implementations, may be provided by one or more data owners. In some implementations, the training data set may comprise a plurality of training examples. In some implementations, each of the training examples may be associated with multiple class labels. In some implementations, the training data set may be stored in data storage 150. The training data processing module 122 may, for example, generate binary classification that partitions observed entities into mutually exclusive “positives” and “negatives”. In some implementations, training data processing module 122 may, for example, generate other types of classifications that divides observed entities into more than two mutually exclusive classes. Additionally, in some implementations, the predictive features for the candidate classifiers may be fixed. In some other implementations, it's worth noting that this approach can be broadened to encompass automatic feature selection. The training data processing module 122 may, for example, define the “positive” and “negative” classes by analyzing the problem at hand. In some implementations, the training data processing module 122 may explore various class definitions, such as setting number-based thresholds for the “positive” and “negative” classes. The training data processing module 122 may, for example, append associated class labels (y1, y2, . . . , yM) to the raw and/or pre-processed training data examples. These labels correspond to alternative class definitions, for example, M labels may correspond to M class definitions. In some implementations, the training data processing module 122 may integrate predictive features into the training examples, wherein the predictive features may comprise the attributes that are relevant for prediction. Further elaboration on training data processing module 122 and the training data set is provided herein elsewhere with greater depth.

In some implementations, the classifier training module 124 may train a set of candidate classifiers, for example, using the training data set prepared by training data processing module 122. In some implementations, the classifier training module 124 may assign random weights to multiple performance objectives for training a set of candidate classifiers. The multiple performance objectives may correspond to multiple class labels. In some implementations, M alternative class definitions may be generated. In some implementations, M may be an integer between 2 and 20. In some implementations, a classifier performance objective function, i.e., Multidivergence, may be defined as:

$$\begin{matrix}MDiv = {\sum }_{m = 1}^{M} {α}_{m} {Div}_{m} \\ = {\sum }_{m = 1}^{M} {α}_{m} \frac{{( {μ}_{mP} - {μ}_{mN} )}^{2}}{0.5 ( {σ}_{mP}^{2} + {σ}_{mN}^{2} )}\end{matrix}$$

where index m counts over the class definitions, Divₘ denotes the Jeffrey's Divergence associated with the m'th class definition, the αₘ are nonnegative coefficients that sum up to 1, μ_{mP} (μ_{mN}) denotes the mean score conditional on positives (negatives) for classing m, and σ_{mP}² (m_{N}) denotes the variance of the score conditional on positives (negatives) for classing m. During training, training data processing module 122 may maximize Multidivergence for N alternative choices of the (α₁, . . . , α_{M}). Each such choice yields a different classifier, resulting in a set of N candidate classifiers. In some implementations, N is much larger than the number of classings M. This may ensure that the Pareto front is covered well with candidate classifiers, as discussed elsewhere herein. The relative sizes of the αₘ values determine how hard the optimization works on separating the score distributions for each of the M class definitions on the development data (e.g., training data set, training examples, etc.). Different choices of (α₁, . . . , α_{M}) result in different tradeoffs of classifier performances across the different class definitions on the assessment sample and/or assessment data set.

Alternatively or additionally, the classifier training module 124 may train customized B-spline GAM (Score=ΣⱼβⱼBⱼ(x)) for each classing m by maximizing a use-specific Divergences Divₘ subject to legal and interpretability constraints; wherein m=1, . . . , M for each of the classings; and wherein S₁, . . . , S_{M} are the associated development sample scores. In some implementations, the use-specific Divergences Divₘ may cover each of the uses that the training data set may be able provide. For example, for a training data set wherein each training example is associated with M classing definitions, M uses may be derived from a classifier trained on this training data set, and therefore M use-specific Divergences Divₘ may be calculated. In some implementations, the use-specific Divergences Divₘ may be defined as:

$${Div}_{m} = \frac{{( {μ}_{mP} - {μ}_{mN} )}^{2}}{0.5 ( {σ}_{mP}^{2} + {σ}_{mN}^{2} )}$$

where m=1, . . . , M for each of the classings
μ_{mP} (μ_{mN}): Mean score conditional on Positives (Negatives) for classing m
σ_{mP}²(σ_{mN}²): Variance of score conditional on Positives (Negatives) for classing m

In some implementations, a set of mix-scores may be defined as weighted linear combinations of customized scores S₁, . . . , S_{M}:

$${S}_{Mix} = {\sum }_{m = 1}^{M} {α}_{m} {S}_{m} ; {α}_{m} \geq 0 ; \sum {α}_{m} = 1$$

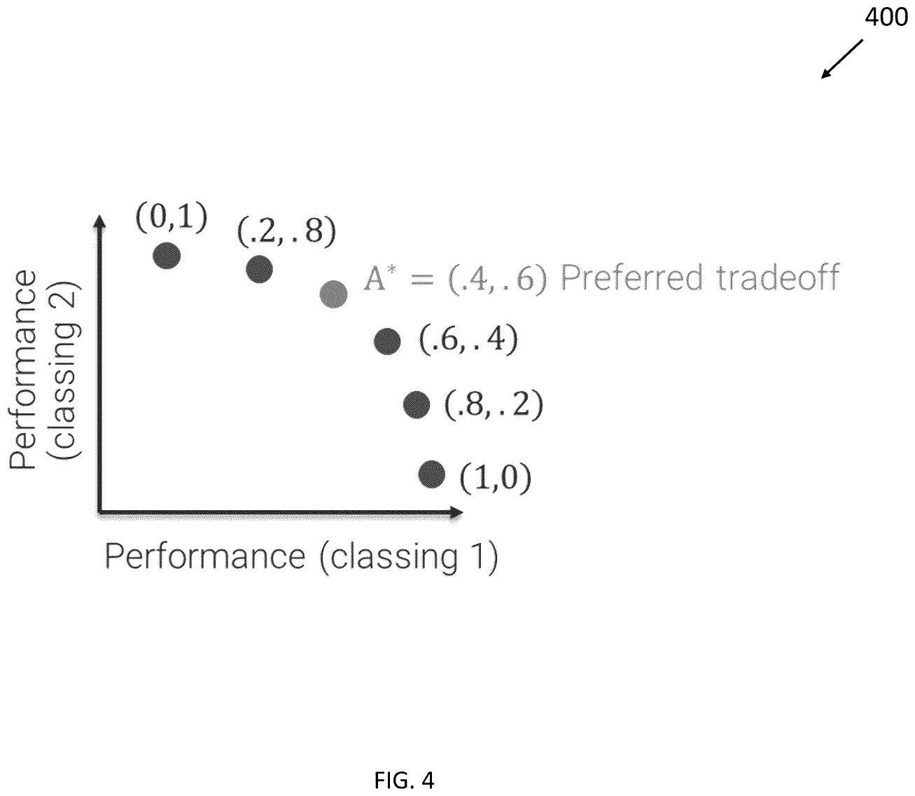

In these implementations the relative sizes of the am values determine the degree of alignment of the mix-score with each of the customized scores on the development data (e.g., training data set, training examples, etc.). Different choices of (α₁, . . . , α_{M}) result in different tradeoffs of the performance of S_{Mix} across the different class definitions on the assessing data. A subset of the candidate classifiers that are trained to maximize a specific use-specific divergence related to a particular performance objective of the multiple performance objectives may be generated. In some embodiments, this subset of the candidate classifiers may include the classifiers as “special cases” where all random weights are set as zero except for one. Therefore, each classifier in this subset is designed to maximize a single specific use-specific divergence. For this subset of classifiers, the classifier training module 124 may generate a set of mix-scores, wherein each mix-score is a randomly weighted linear combination of customized scores generated by each of the subset of the candidate classifiers. The customized scores may be the outputs of the customized B-spline GAMs as an example of the classifiers, each tailored to maximize a specific use-specific divergence for the corresponding performance objective. The mix-scores are then ranked to select a combination of weights associated with the highest ranked mix-score, which reflects the preferred tradeoff between the various performance and/or training objectives. Using the selected combination of weights, a preferred classifier can be constructed, thereby optimizing the balance between different performance objectives. FIG. 4 illustrates the performance tradeoffs of six classifiers within the context of two objectives. As shown in FIG. 4, wherein two classing definitions (i.e., two class labels) may be added/appended with the training examples in the training data set and/or with the assessing examples in the assessing data set, and therefore, the performance of each of the candidate classifiers may be assessed and a score may be calculated, In some implementations, calculating the score may involve calculation of a score associated with each of the classifiers, as described herein elsewhere. As shown in FIG. 4, the classifier training module 124 may entertain sufficiently fine grid, or random scatter, of A=(α₁, . . . , α_{M}) to cover M−1 dimensional space well. As shown in FIG. 4, for each choice of the random weights assigned to the scores S₁, . . . , S_{M}, one classifier may be generated, trained, and evaluated, across M dimensions (e.g., two in the use case shown in FIG. 4). In some implementations, as shown in FIG. 4, one of the candidate classifiers may be only trained on training examples with classing 1 labels, and one of candidate classifiers may be only trained on training examples with classing 2 labels, as their associated choice of assigned weights are (0,1) and (1,0). As shown in FIG. 4, A* may represent a preferred tradeoff. In some implementations, the classifier training module 124 may derive B-spline coefficients for the preferred Generalized Additive Model (GAM) as A*, which may be a weighted linear combinations of the customized GAM coefficients.

### Feature Influence Objective

As discussed herein elsewhere, the possibility of classifiers being manipulated by users who understand the model's dependencies on predictive features is a concern that can undermine the integrity and effectiveness of the classification system. For example, in the context of the school's use of a classifier to assign academic mentors, the feature ‘times late last month’ has been identified as a strong predictor for determining which students are at the greatest risk of worsening grades. However, with the school's policy of transparency regarding the decision-making criteria, there is a risk that students may attempt to exploit this knowledge by intentionally arriving late more frequently, thereby manipulating their likelihood of being assigned a mentor. To address this issue, a modification to the final model may be desired, which would reduce the weight or influence of the times late last month' feature. This adjustment aims to diminish the incentive for students to engage in strategic classification, where they might alter their behavior in ways that are detectable by the classifier but are not genuinely indicative of their risk level. By downplaying this feature, the model becomes more robust against such gaming tactics, ensuring that mentorship assignments are based on a more holistic and less gameable assessment of students' risk of worsening grades.

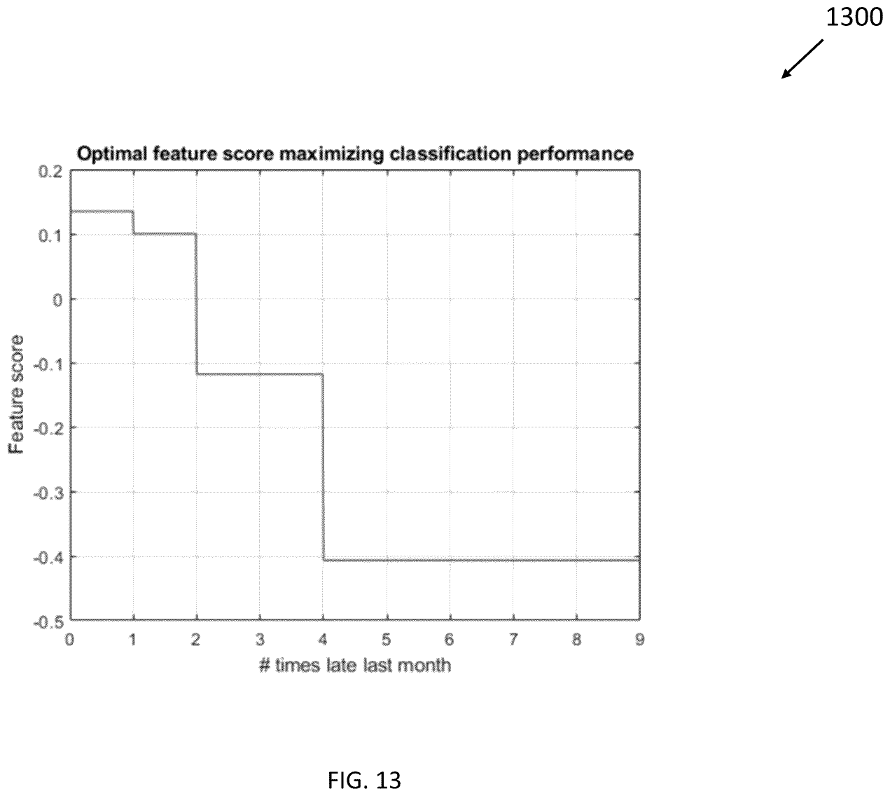

In some embodiments, if score manipulation is a concern, then the classifier training module 124 may further train the initially trained classifiers under an additional set of objectives, i.e., feature influence objectives. For example, the classifier training module 124 may trains a customized B-spline GAM (Score=ΣⱼβⱼBⱼ(x)). The Bⱼ are B-spline basis functions and the βⱼ are coefficients associated with the basis functions. The coefficients βⱼ can be the output of a mathematical optimization to maximize the objective function MDiv. In some embodiments, the additive contribution of feature Xₖ; k=1, . . . , K to the GAM Score of an initial model that maximizes the MDiv objective function, is:

$$Initial Features Score ( {X}_{k} ) = {\sum }_{j ∈ {J}_{k}} {β}_{j}^{Initial} {B}_{j} ( x )$$

where Jₖ denotes the index set of B-spline basis functions associated with feature Xₖ. FIG. 13 depicts the Feature Score of Xₖ=‘#times late last month’ for the initially trained classifiers. As shown in FIG. 13, the initial feature score of ‘#times late last month’ declines sharply when arriving late more than twice. In some embodiments, this sharp decline in the initial feature score of the feature ‘times late last month’ when arriving late more than twice indicates that the feature has a strong influence on the classifier's decision-making process. for example, it may suggest that as the number of times a student is late increases beyond a threshold (in this case, more than twice), the impact on the student's score—and consequently their likelihood of being assigned a mentor—decreases rapidly. This sharp decline can be interpreted as the model heavily penalizing students for being late more than a couple of times, which could be a strong predictor in the model for determining students at risk of worsening grades. However, this also raises concerns that students might game the system by intentionally showing up late to meet the criteria for mentorship, which is why the model developer may want to adjust the influence of this feature to prevent such strategic behavior.

To address this issue, the classifier training module 124 may further downplay the influence of this feature on the model. In some embodiments, let ρ be a positive scale coefficient. A Desired Feature Score is defined as follows:

$$Desired Feature Score ( {X}_{k} ) = ρ * Initial Feature Score ( {X}_{k} )$$

Hence:

$$Desired Feature Score ( {X}_{k} ) = {\sum }_{j ∈ {J}_{k}} ρ * {β}_{j}^{Initial} {B}_{j} ( x )$$

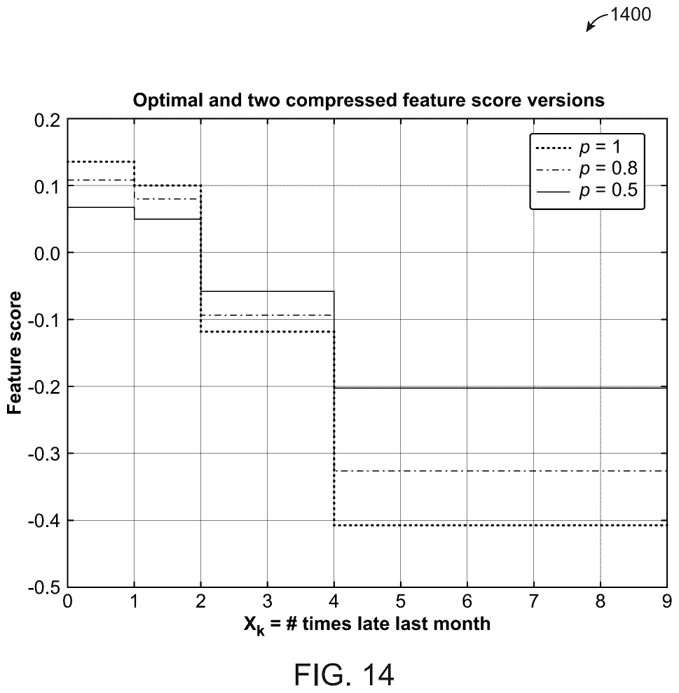

If 0≤ρ<1 is chosen, then the Desired Feature Score is a down-scaled version of the Initial Feature Score. FIG. 14 compares the Initial Feature Score of Xₖ=‘#times late last month’ with down-scaled Feature Score versions for two alternative values of ρ. As shown in FIG. 14, the initial feature score and two down-scaled versions of Feature Score are presented. Down-scaled versions decline more moderately when arriving late more than twice, the amount of decline being controlled by the scale factor ρ.

As discussed, the Desired B-spline coefficients are defined as:

$${β}_{j}^{Desired} = ρ * {β}_{j}^{Initial}$$

In some embodiments, the model developer could manually edit the final model coefficients by substituting βⱼ^{Desired}=0.5*βⱼ^{Initial} for the initial coefficients, such that the Feature Score matches the dotted line in FIG. 14. However, such a drastic deviation from the initial model might reduce the model's classification performance too much. After some trial-and-error the model developer might find that the substitution βⱼ^{desired}=0.8*βⱼ^{Initial} such that the Feature Score matches the dash-dotted line in FIG. 14 strikes a better balance between retaining acceptable classification performance while materially down-playing the feature's influence. However, this manual approach to coefficient adjustment lacks efficiency and does not provide any guarantee of achieving an optimized solution. It may result in a model that is suboptimal, as it could be possible to improve the balance between classification performance and feature influence in a more systematic and reliable manner.

In some embodiments, uses for down-scaling the influences of one or more features arise when certain features are expected to lose some of their predictive power due to data drift under future expected operating conditions for the model/classifier, the above strategic classification (i.e., score gaming) example are presented only as an example. It can be sensible to reduce the reliance of a model on any given features by reducing the features' influence in the design of the model. In some embodiments, features whose data distribution drifts faster could be down-scaled more aggressively, while some other features whose data distribution drifts slowly may be down-scaled more modestly. Different values in the interval 0≤ρ<1 might be appropriate for different features to judiciously down-scale their respective influences.

In some embodiments, up-scaling may be beneficial for features that are stable, non-manipulable, and contribute to model clarity and user trust. Such features may warrant a scaling factor of ρ>1 to enhance their impact on the model's output. Furthermore, up-scaling can be strategically used to drive desired behaviors in scored entities. For instance, amplifying a feature that rewards homework completion can motivate students towards behaviors that increase their likelihood of academic success. Additionally or alternatively, there may be more than one feature in a model which the model developer wants to down-scale or up-scale, making the naïve model editing approach highly ineffective. To address this issue, the classifier training module 124 may uses optimization to find the Pareto-optimal tradeoff solutions that cannot be improved in any one dimension without losing on some other dimension(s). The GAM classifier performance objective function is enhanced with an additional set of terms that encourage the trained optimal βⱼ to be close to the desired βⱼ^{Desired} for all features whose influence are chosen to be controlled, as follows:

$$MDiv\_enhanced = MDiv - BetaDist$$

$$Where BetaDist = {\sum }_{k = 1}^{K} {( {β}_{j} - {ρ}_{k} * {β}_{j}^{Initial} )}^{2}$$

is a summary measure of the distances between the B-spline coefficients of the trained classifiers from the desired B-spline coefficients.

The classifier training module 124 may then train the classifier to maximize MDiv_enhanced. This encourages large values of MDiv and small values of BetaDist, the latter encouraging the influences of the trained Feature Scores to be close to up-scaled or down-scaled versions of the initial model's Feature Influences. Minimizing the distance between the desired coefficients and the initial coefficients may balance the objectives of maintaining the classifier's original predictive performance while also adjusting the influence of specific features to achieve additional goals, such as preventing strategic gaming or addressing fairness concerns.

In some embodiments, the classifier training module 124 may train a multitude of classifiers to maximize MDiv_enhanced for different, randomly distributed tuples of (ρ₁, . . . ρ_{K}). In some embodiments, the classifier training module 124 may generate the random distribution such that for features to down-scale, the random values are distributed within the interval μ_{low}≤ρ<1 where ρ_{low}>0 is a user-defined lower bound that can prevent features from being down-scaled too excessively. In some embodiments, the classifier training module 124 may generate the random distribution such that for features to up-scale, the random values are distributed within the interval 1<ρ<ρₕᵢ where ρₕᵢ>1 is a user-defined upper bound that can prevent features from being up-scaled too excessively. In some embodiments, the default values ρ_{low}=0.5 and ρₕᵢ=2 are set to prevent excessive re-scaling of the initial Feature Scores.

In some embodiments, the classifier training module 124 may maximize MDiv_enhanced for N2 alternative choices of the combined vector of randomly generated coefficients (α₁, . . . , α_{M}, ρ₁, . . . , ρ_{K}). Each such choice may yield a different classifier on the Pareto frontier for the multi-objective function MDiv_enhanced, resulting in a set of N2 candidate classifiers. In some embodiments, N2 may be larger than N to make sure that the now higher-dimensional Pareto Front of dimension M+K is well covered with candidate classifiers.

Referring back to FIG. 1, the classifier assessing module 126 may assess the performances associated with classifiers. In some implementations, the classifier accessing module 126 may generate an assessment data set for assessing the classifiers. In some implementations, the optional assessing data processing module 125 may generate the assessment data set for assessing the classifiers. In some implementations, the classifier accessing module 126 may then assess each of the N candidate classifiers using the assessment data set comprising the predictive features of the assessment data set. In some implementations, the assessment data set comprises a plurality of evaluation examples, and each of the evaluation examples is associated with multiple evaluation class labels. The multiple evaluation class labels can be a different set of labels compared to multiple class labels associated with the training examples.

In some implementations, the classifier assessing module 126 may assess each classifier of the candidate classifiers to generate multiple performance measurements for each of the set of candidate classifiers. In some implementations, each of the multiple performance measurements is associated with each of the multiple training objectives/performance objectives. For example, for a set of N classifiers that are associated with three training objectives/performance objectives, three scores may be generated for each of the classifiers, wherein each score of the three scores is indicative of the performance of this classifier for one of the performance objectives. In some implementations, for each of the N classifiers that were trained under M class definitions, a tradeoff table with N*M data points may be generated. The data points in the tradeoff table may be partially based on the multiple performance measurements for each of the candidate classifiers. In some implementations, when the feature influence objective is also part of the training objectives, the impacts associated with a set of K number of predictive features may be taken into account when further training the initially trained classifiers. Therefore, for each of the N classifiers that were trained under M class definitions, a tradeoff table with N*(M+K) data points may be generated. The data points in the tradeoff table may be partially based on the multiple training measurements for each of the candidate classifiers.

In some implementations, the classifier assessing module 126 may assess each classifier of the candidate classifiers with respective to each of the multiple performance objectives, by, for example, first generating a score for each of the candidate classifiers. Additionally or alternatively, the classifier assessing module 126 may first generate a score by scoring out the training or assessing examples with each of the candidate classifiers. In some implementations, subsequent to generating a score for each of the candidate classifiers, the classifier assessing module 126 may then evaluate the score performance associated with each classifier, on each of the performance objectives. In some implementations, for each of the N classifiers their performance under M class definitions is evaluated, from which a tradeoff table with N*M performance objective measures may be generated. The data points (performance objective measures) in the tradeoff table may be based on the multiple performances under the M class definitions, for each of the candidate classifiers.

The interactive user experience delivery engine 128 may operate to deliver a visualization of the tradeoff table to one or more client nodes 102 and/or 106, for example, via a display of the client nodes. In some implementations, the interactive user experience delivery engine 128 may deliver the visualization of the tradeoff table along with dynamic interactive user experience. In some implementations, the visualization of the tradeoff table may illustrate corresponding performances across different corresponding objectives of the multiple performance objectives. In some implementations, the dynamic interactive user experience may allow a user to adjust a level of focus on a first set of the multiple performance objectives. In some implementations, the visualization of the tradeoff table may dynamically present a corresponding adjustment to a level of focus on a second set of the multiple performance objectives in response to the user adjusting the level of focus on the first set of the multiple performance objectives. In some implementations, the interactive user experience delivery engine 128 may deliver the corresponding adjustment to a level of focus on a second set of the multiple performance objectives in real-time or near real-time. As described herein elsewhere, the classifiers that are dominated by other classifiers (i.e., the subset of classifiers where each classifier of the subset is outperformed by at least one classifier across all performance objectives of the multiple performance objectives) has proven inferior to at least one other classifier. Therefore, the interactive user experience delivery engine 128 may remove this subset of classifiers from the visualization.

In some implementations, the server platform 120 may receive an affirmative instruction from the client nodes 102 or 106 associated with a user, and may generate a resultant classifier for output.

Data access modules 142 may facilitate access to data storage 150 of the server platform 120 by any of the remaining modules 122, 124, 126, and 128 of the server platform 120. In one example, one or more of the data access modules 142 may be database access modules, or may be any kind of data access module capable of storing data to, and/or retrieving data from, the data storage 150 according to the needs of the particular modules 122, 124, 126, and 128 employing the data access modules 142 to access the data storage 150. Examples of the data storage 150 include, but are not limited to, one or more data storage components, such as magnetic disk drives, optical disk drives, solid state disk (SSD) drives, and other forms of nonvolatile and volatile memory components.

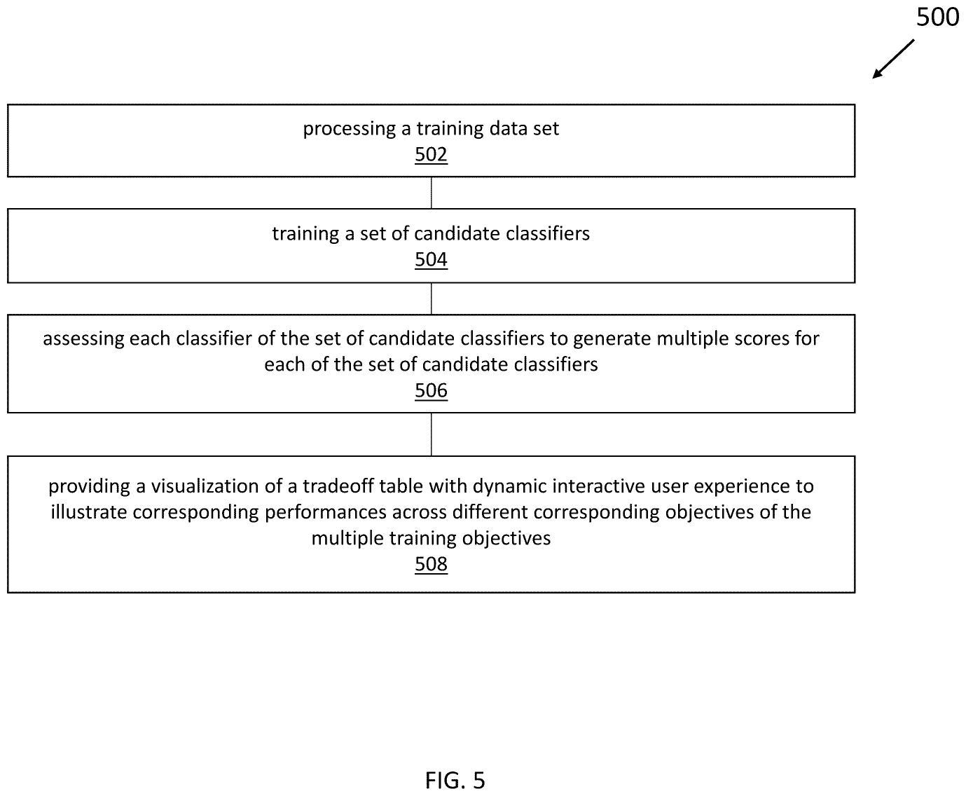

FIG. 5 is a flow diagram depicting an example process 500 for delivering interactive user experience, according to one exemplary implementation. The process may be performed by the system 100 of FIG. 1. As depicted in FIG. 5, once the platforms and systems of the present disclosure are initialized, the process 500 begins with operation 502, wherein the system 100 processes and/or prepares a training data set, for example, by utilizing the training data processing module 122. In some implementations, the training data set may comprise a plurality of training examples, wherein each of the training examples may be associated with multiple class labels. The process 500 may then proceed to operation 504, wherein the system 100 may train a set of candidate classifiers, for example, by utilize the classifier training module 124. In operation 504, the classifier training module 124 may train a set of N candidate classifiers, for example, using the training data set prepared by training data processing module 122 in operation 502. In some implementations, the classifier training module 124 may assign random weights to multiple performance objectives for training a set of candidate classifiers. The multiple performance objectives may correspond to multiple class labels. In some implementations, M alternative class definitions may be generated. In some implementations, M may be an integer between 2 and 20.

Next, the process 500 may proceed to operation 506, wherein the system 100 may assess each classifier of the set of N candidate classifiers, for example, by utilizing the classifier assessing module 126 to generate multiple performance measurements for each of the set of candidate classifiers. In some implementations, in the operation 506, the system may utilize the classifier assessing module 126 to generate a score and evaluate its performance under multiple objectives, for each of the classifiers in the set of candidate classifiers. In some implementations, the classifier assessing module 126 may generate an assessment data set for assessing the classifiers, and assess each of the N candidate classifiers using the assessment data set. In some implementations, the assessment data set comprises a plurality of evaluation examples, and each of the evaluation examples is associated with multiple evaluation class labels. The multiple evaluation class labels can be a different from the multiple class labels associated with the training examples. In some implementations, the classifier assessing module 126 may assess each classifier of the candidate classifiers to generate multiple performance measurements for each of the set of candidate classifiers. In some implementations, each of the multiple performance measurements is associated with each of the multiple training objectives/performance objectives. For example, for a set of N classifiers that are associated with three training objectives/performance objectives, three scores may be generated for each of the classifiers, wherein each score of the three scores is indicative of the performance of this classifier for one of the performance objectives. In some implementations, for each of the N classifiers that were trained under M class definitions, a tradeoff table with N*M data points may be generated. The data points in the tradeoff table may be partially based on the multiple performance measurements for each of the candidate classifiers. In some implementations, the classifier assessing module 126 may assess each classifier of the candidate classifiers with respective to each of the multiple performance objectives, by, for example, first generating a score for each of the candidate classifiers. Additionally or alternatively, the classifier assessing module 126 may first generate a score by scoring out the training or assessing examples with each of the candidate classifiers. In some implementations, subsequent to generating a score for each of the candidate classifiers, the classifier assessing module 126 may then evaluate the score performance associated with each classifier, on each of the performance objectives. In some implementations, for each of the N classifiers their performance under M class definitions is evaluated, from which a tradeoff table with N*M performance objective measures may be generated. The data points (performance objective measures) in the tradeoff table may be based on the multiple performances under the M class definitions, for each of the candidate classifiers.

Next, the process 500 may proceed to operation 508, wherein the system 100 may provide a visualization of a tradeoff table with dynamic interactive user experience to a user, for example, by using interactive user experience delivery engine 128. In some implementations, the visualization of the tradeoff table may illustrate corresponding performances across different corresponding objectives of the multiple performance objectives. In some implementations, the dynamic interactive user experience may allow a user to adjust a level of focus on a first set of the multiple performance objectives. In some implementations, the visualization of the tradeoff table may dynamically present a corresponding adjustment to a level of focus on a second set of the multiple performance objectives in response to the user adjusting the level of focus on the first set of the multiple performance objectives.

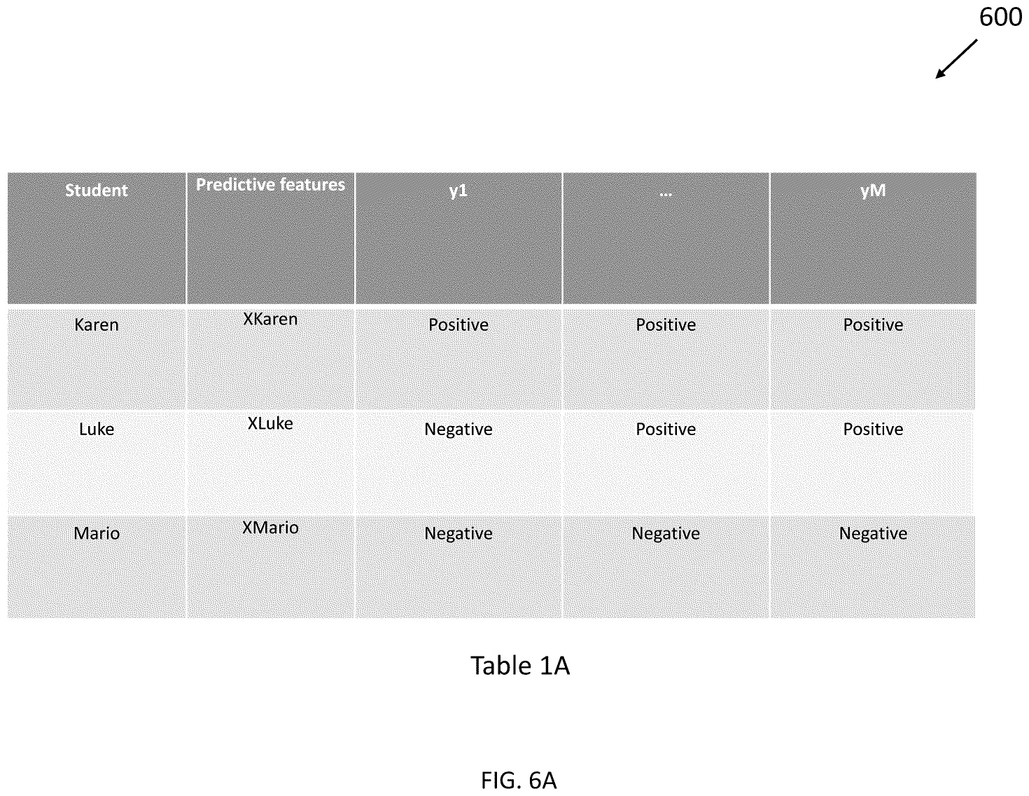

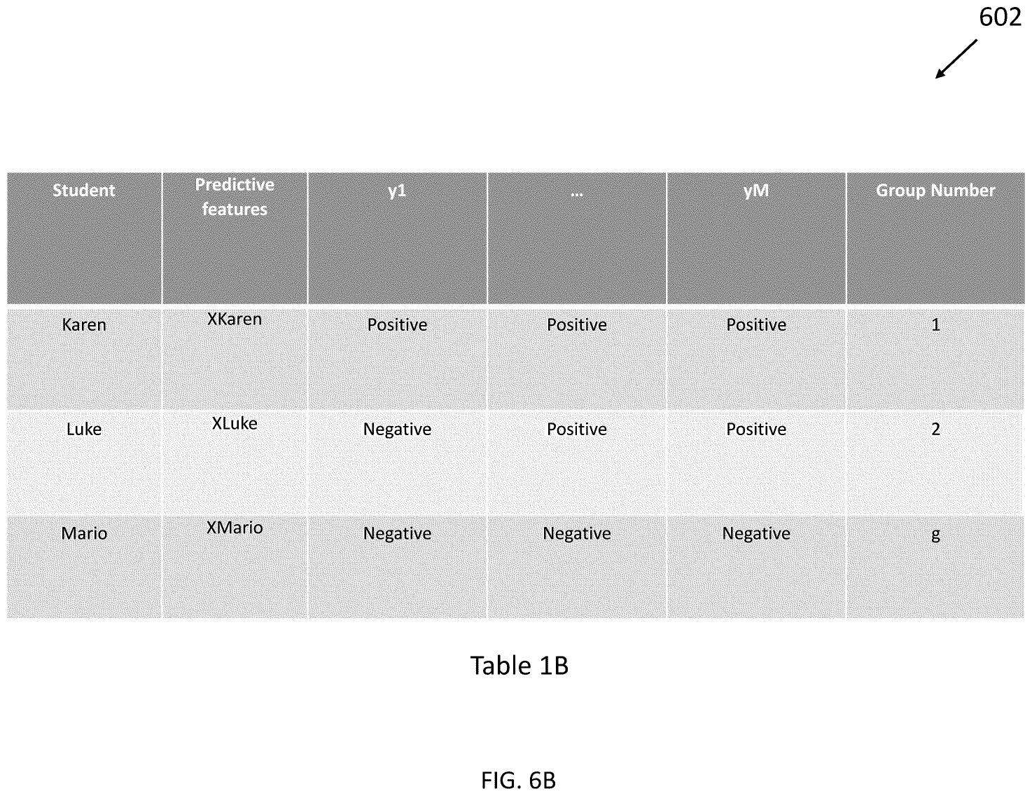

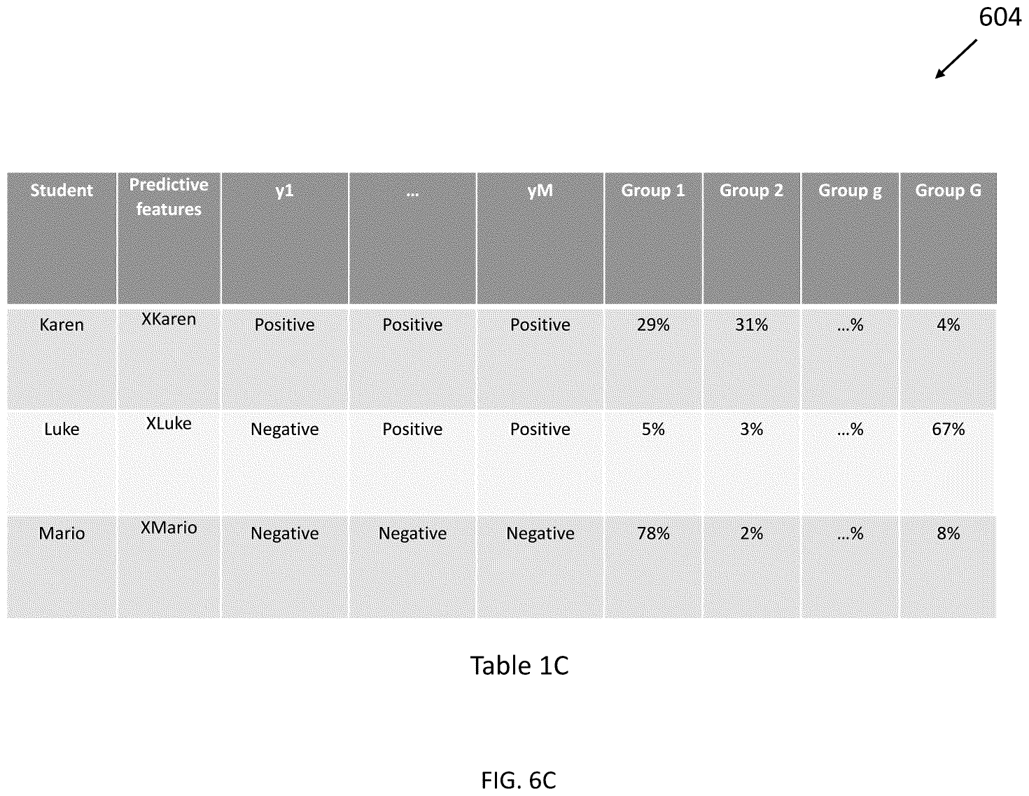

In exemplifying the subject matter herein and providing detailed description, consider the objective of predicting prospective educational success among students. FIG. 6A illustrates class labels y1, . . . , yM associated with the alternative class definitions to the development data (e.g., training data set). In the context of binary classification, the categorization of students' educational accomplishments into positive and negative outcomes may be essential. Among the array of rational class definitions, the following possibilities emerge:
Establishing a predetermined threshold, denoted as T, for the average grade achieved over the upcoming K semesters. By employing subjective judgment over T and/or K, entities (e.g., students) with average grade values surpassing the established threshold are designated as positive, while those falling below it are designated as negative.
Designating students who successfully complete the educational program as positive, while categorizing those who discontinue (i.e., drop out) the program as negative.
Refine the dropout definition with a reason such as:
   Dropout due to social factors;
   Dropout due to reading difficulties;
   Dropout due to illness

In some implementations, knowledge pertaining to a forthcoming specialized use case for the scoring system may play a decisive role in shaping the classification methodology and potentially reducing the range of practical alternative class definitions. For instance, envisioning the utilization of the score to proactively notify educators about students at risk of encountering suboptimal future grades introduces a plausible rationale for adopting a grade average-based class definition. Under this scenario, ‘negative’ could be designated for those who attain a grade below a “C-” or, alternatively, a grade below a “D”. Conversely, if the objective involves assigning students to a social support program, a class definition grounded in the context of “dropout due to social factors” could present a more fitting framework for ‘negative’ classification.

In some implementations, this kind of knowledge regarding the use case for the classifiers might not always be accessible during the phase of developing the classifier, or the situation might involve the envisioning of several potential future use cases. Additionally, the applicability of a score could extend to alternative contexts that were not originally foreseen. This adaptability becomes evident when the evaluation of performance indicates strong predictive capabilities for alternative class definitions. Potential users of the score may build a sense of trust if the classifier consistently performs well across diverse performance definitions. For instance, consider the perspective of a school board, which might evaluate a classifier's predictive efficacy and robustness across M alternative class definitions:
Classing 1: Identifying students whose upcoming semester grade average is projected to be below a “C-” compared to those expected to achieve “C-” or higher.
Classing 2: Differentiating students whose upcoming semester grade average is anticipated to fall below a “D” versus those anticipated to attain “D” or higher.
Classing 3: Separating students who are likely to discontinue due to reason #1 from those who are expected to successfully complete the program.
Classing M: Distinguishing students who are predicted to discontinue due to reason #K from those who are projected to successfully complete the program.

As shown in FIG. 6A, the training data set may be appended with M class labels y1, . . . , yM, wherein each of the training examples (i.e., each student as an individual date entry) is associated with M alternative class definitions. In this manner, the classifier's performance may be scrutinized across various class definitions, contributing to an informed evaluation by the school board. A score that consistently demonstrates robust performance across multiple assessment criteria holds the potential for diverse applications, including ones that were not initially considered. Such a score might garner more trust than a score that excels solely for one specific class definition while performing inadequately for alternative class definitions.

Next, in some implementations, a collection of N classifiers (i.e., a set of candidate classifiers) is trained using the data provided in Table 1A shown in FIG. 6A. Assuming that the developer of the classifier has formulated M distinct alternative class definitions. Generally, the value of M is expected to be moderate, often ranging between 2 and 20. The classifier performance objective function, designated as the “Multidivergence,” is described herein elsewhere. In some implementations, additional or alternation classifier performance objective function, designated as “mix-score,” is described herein elsewhere.

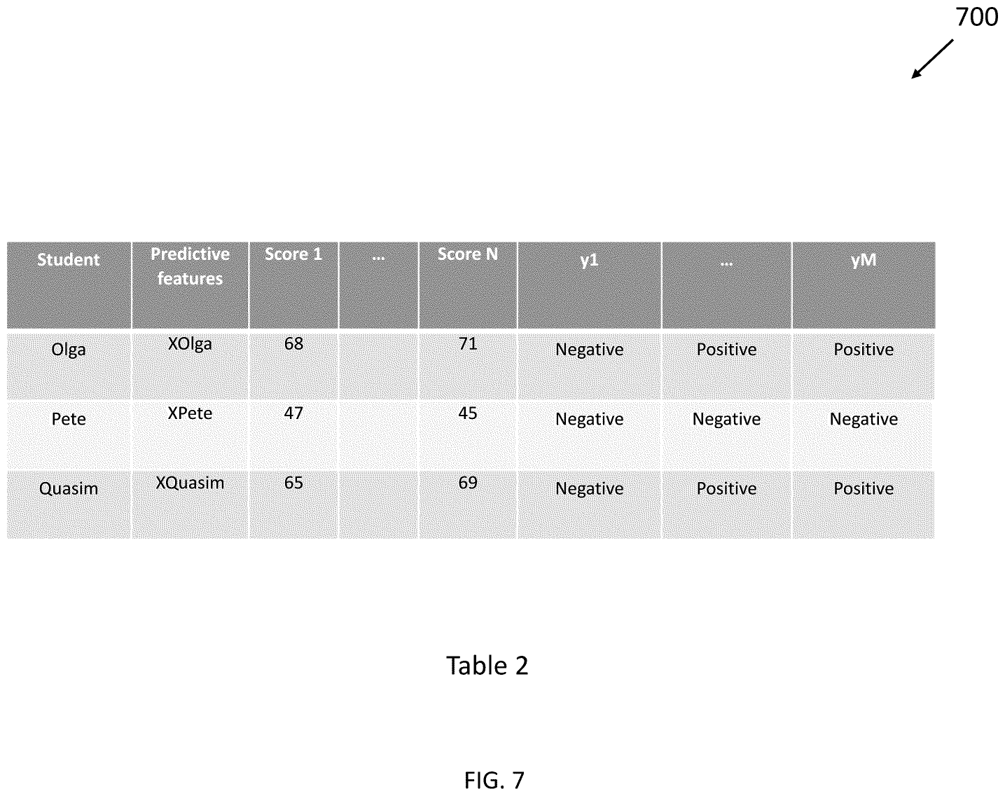

Once the set of classifiers is trained, the assessment data may be prepared and/or generated. In some implementations, the assessment data may be subjected to scoring using the N classifiers that were trained during classifier training process, leveraging the predictive features of the assessment students. The N resultant score variables may be integrated into the assessment data. Simultaneously, the diverse alternative class labels may be appended to the assessment data. In some implantations, the class definitions utilized for assessment can inherently differ from those employed during the development of the classifier. For the sake of simplicity and without compromising the overall applicability, the process of assessment presented here uses identical class definitions for both development (e.g., classifier training) and assessment phases. In this context, the M alternative class labels are appended to the assessment data, as illustrated in Table 2 of FIG. 7. The assessment data set can be used to score out the students with each of the N candidate classifiers, resulting in N scores. Thereafter each of the N scores associated with the N classifiers is evaluated under each of the M classing definitions. The resulting N*M performance measures are collected in a tradeoff table.

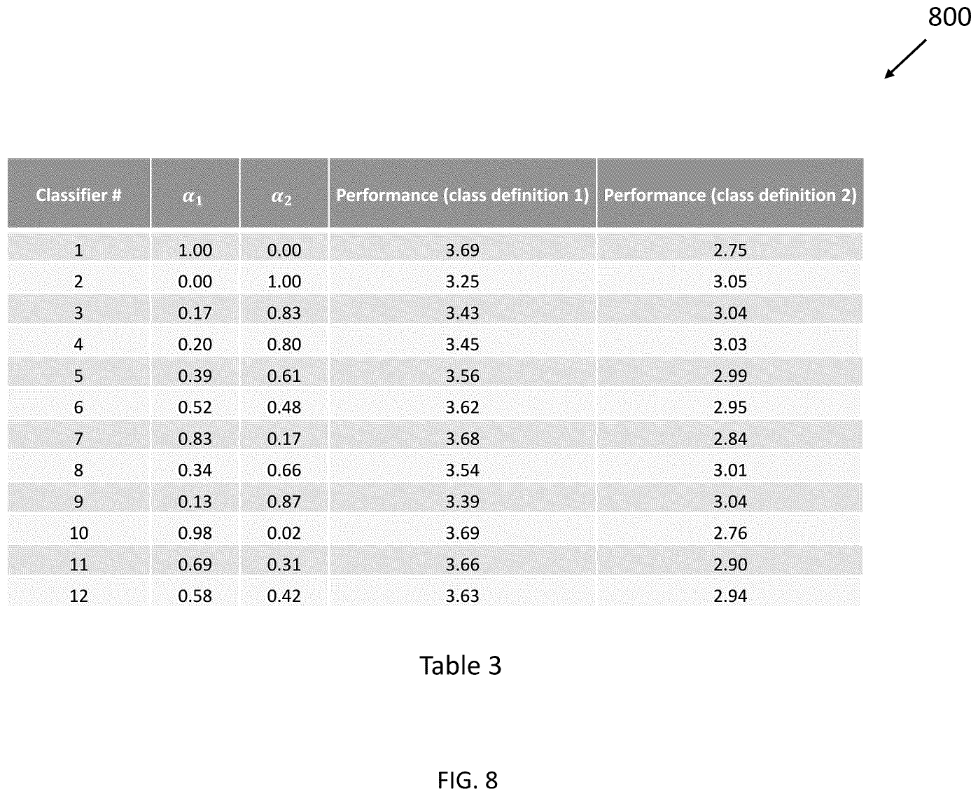

FIG. 8 illustrates an exemplary tradeoff table where performance of a set of N=12 classifiers is evaluated on M=2 class definitions, according to one or more implementations of the current subject matter. As shown in FIG. 8, the evaluation of classification performance for each of the N scores concerning each of the M class definitions may be systematically conducted. This evaluation process allows for the comprehensive depiction of performance variations. For clarity, as shown in FIG. 8, Classifier #1 was exclusively trained on class definition 1, while Classifier #2 was solely trained on class definition 2 (i.e., as indicated by the (1,0) and (0,1) alpha values, respectively). Classifiers #3 to #12 underwent training using both class definitions, guided by randomly chosen tuples (α₁, α₂) tuples, as delineated during the candidate classifier training process.

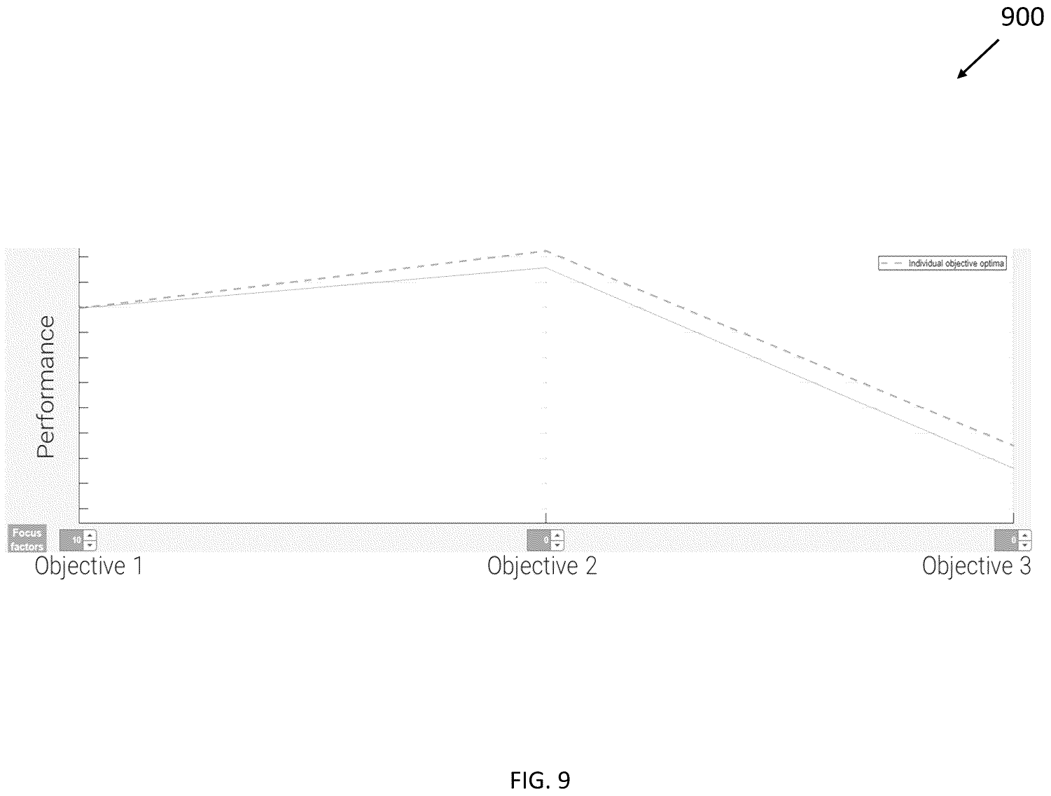

FIG. 9-11 illustrate an exemplary graphical user interface (GUI)-based visualization designed to facilitate the interactive elicitation of the decision maker's favored classifier from the pool of candidate classifiers. An illustration encompassing several iterations of the elicitation process is provided, focusing on a scenario involving M=3 classification performance objectives. It is noteworthy that additional iterations, which are not depicted here, can be incorporated to provide the decision maker with the opportunity to further refine their preferred tradeoff. As shown in FIG. 9-11, the performance of each objective materializes in a visual presentation via a parallel coordinate plot. In some implementations, the number of objectives might surpass three. In such cases, additional objectives would be seamlessly included by appending further columns to the display interface.

During each iteration of the process, two distinct lines are presented:

As shown in FIG. 9-11, the dashed line serves as a representation of the performance achieved by the most proficient classifier among the candidates for each of the 3 classification performance objectives. This line acts as an upper performance limit and a reference point against which other candidates are measured in terms of their performance degradation compared to the individual optima. It is important to note that the dashed line remains constant across all iterations. The solid line signifies the performance of the “winning” candidate for the current iteration. This “winning” candidate is determined by possessing the highest value of the present preference function (PF) when compared to all other candidates. The preference function (PF) allows the decision maker to provisionally articulate their preferences for the various classification performance objectives. This expression is facilitated through the assignment of “Focus Factors” (FF), which can be adjusted by the decision maker through the graphical user interface (GUI) corresponding to each respective objective.

Upon observing the performance tradeoff achieved by the current winner, the decision maker retains the capability to modify the Focus Factors (FFs) within the GUI. This allows them to navigate toward a more favorable tradeoff that aligns with their preferences. When any adjustments to the FFs are identified by the GUI, the candidate classifiers may undergo a re-ranking based on the updated preference function. If this re-ranking results in the emergence of a new “winner,” the solid line is updated accordingly to visually depict the newly attained tradeoff established by the new winner.

An example of a PF is:
PF=FF1×Performance(objective 1)
+FF2×Performance(objective 2)
+FF3×Performance(objective 3)

Other PF formulas may also be possible, such as involving nonlinear transformations of performance measures, or percentage loss-scaled performance measures with respect to the individual optima per the dashed line.

As shown in FIG. 9, in the initial iteration, the decision maker's attention is solely directed towards objective 1. This may be accomplished by assigning a value of 10 to FF1, while FF2 and FF3 are both set to 0. As per the decision maker's current prioritization, the solid line mirrors the performance achieved by the top-performing classifier among the candidates specifically for objective 1. However, the decision maker may express discontent with the performance exhibited by this particular classifier in relation to objectives 2 and 3.

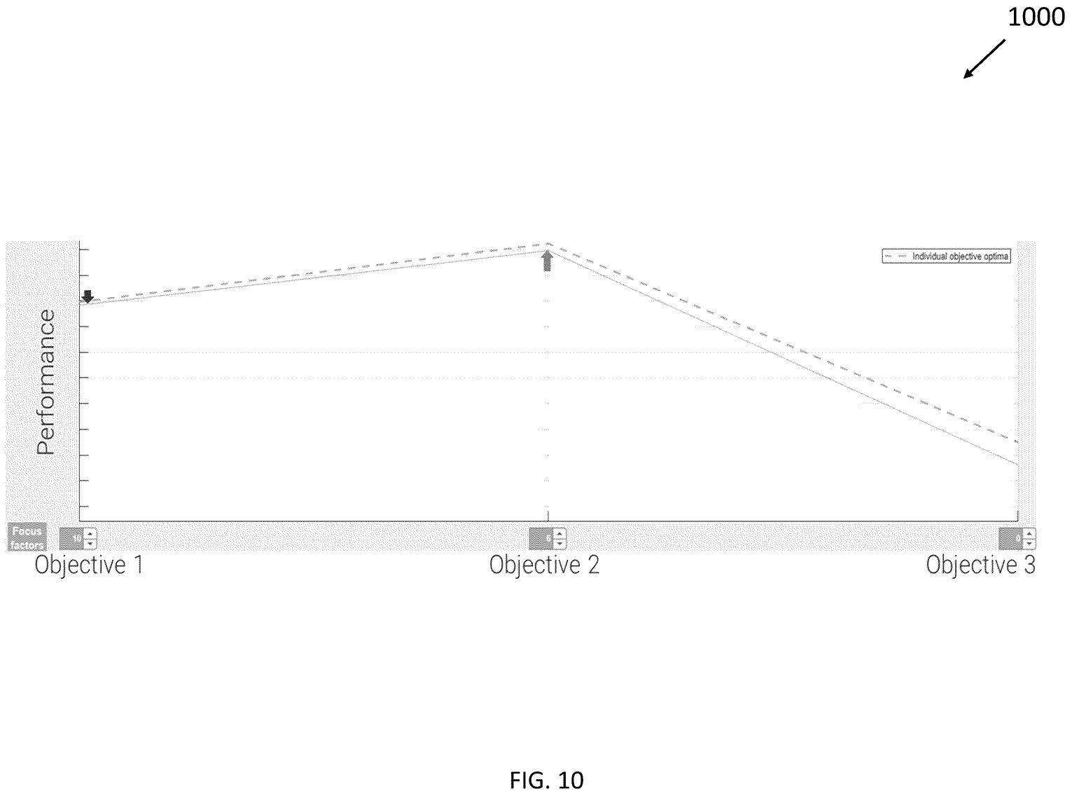

As shown in FIG. 10, the decision maker may intend to enhance performance in objective 2 and, to achieve this, assigns a value of 6 to FF2. Consequently, a fresh candidate classifier is identified through the optimization of the decision maker's revised preference function (PF). The newfound winner demonstrates significant improvement in achieving objective 2, while simultaneously incurring a negligible decrease in performance concerning objective 1. Notably, objective 3 may remain largely unchanged. Despite these adjustments, the decision maker's dissatisfaction with the performance regarding objective 3 may persist. As such, the visualization of the tradeoff table dynamically presents a corresponding adjustment to a level of focus on a second set of the multiple performance objectives in response to the user adjusting the level of focus on the first set of the multiple performance objectives.

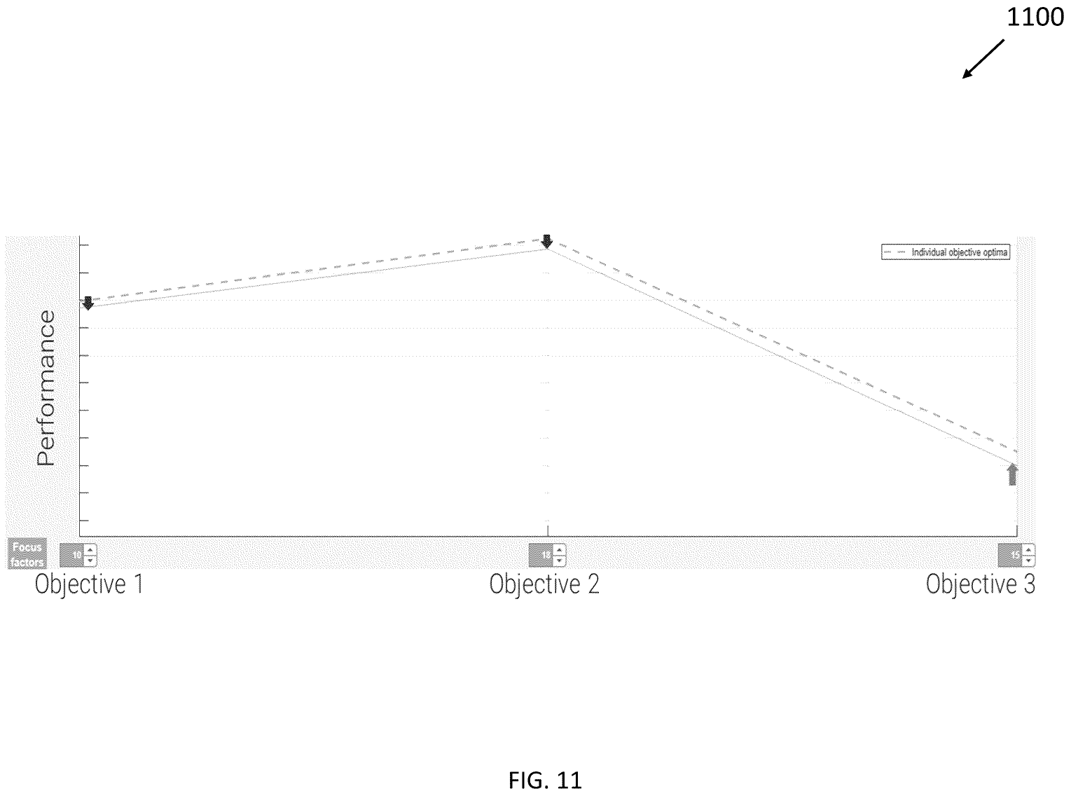

As shown in FIG. 11, the decision maker may seek to elevate performance in objective 3 and therefore assigns a value of 15 to FF3. Following further adjustments, which are not depicted here, the decision maker sets FF2 to 18. This sequence of actions leads to the identification of a new winner, strategically aligned with the maximization of the decision maker's revised preference function (PF). Notably, this fresh winner significantly advances performance in objective 3, with only marginal declines observed in objectives 1 and 2. As a result, the decision maker attains contentment with this achieved performance tradeoff, and may provide an affirmative instruction. Consequently, the decision maker opts for the current winner as their preferred classifier, and the platform may output this resultant classifier for later deployment by the user.

### Fairness Objective

As discussed herein elsewhere, fairness in classifier may be approached from various angles depending on the specific fairness criteria being targeted. Fairness may involve ensuring that different demographic groups receive similar outcomes when using the classifier, such as similar rates of being offered a mentorship program or similar access to resources in the examples herein. This can be particularly challenging when sensitive group membership information is not available at the time of classifier deployment due to privacy, legal, or data veracity concerns. Therefore, the technology described herein may utilize information available at the time of training the classifier, such as historical data with verified group memberships or probabilistic estimates of group membership, to adjust the classifiers' score distributions in a way that aligns with desired fairness criteria. By incorporating additional objectives into the classifier training process, the technology may strike a balance between maintaining high classification performance and achieving fairness across different groups, thereby promoting equitable treatment in automated decision-making processes.

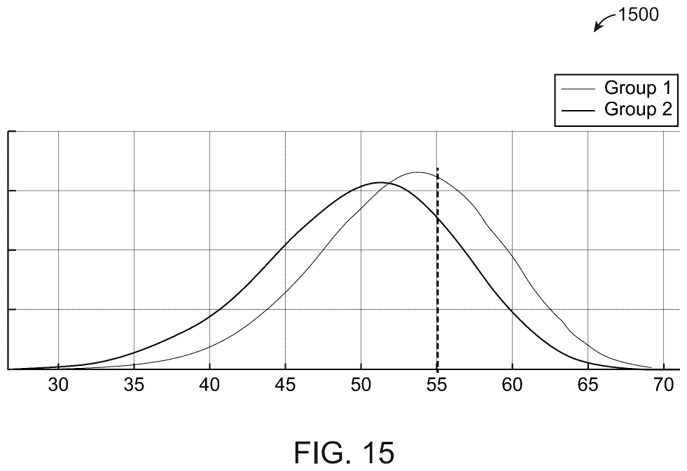

In some embodiments, the classifier training module 124 in FIG. 1 may additionally train the classifiers under fairness objectives. For example, the trained classifiers may generate substantially different score distributions for the groups. In some embodiments, this score distribution differences could result in materially different outcome across different groups. For example, as shown in FIG. 15, score distribution differences could result in materially different program admission rates (e.g., mentor assignment rate) between group 1 and group 2. As shown in FIG. 15, score distributions generated by a trained classifier for a score varies between group 1 and group 2. In FIG. 15, Vertical axis represents smoothed probability density of the score variable. In the mentor assignment example, if all students whose score is below a threshold of 55 receive mentorship, then students from Group 1 will receive mentorship benefits at a substantially lower rate than students from Group 2. This demonstrates the problem of unequal treatment and potential bias in classifier outcomes. To address this problem, the group fairness objective may be added to the multiple training objectives, which is described in further details.

In some embodiments, the training data set 600 as shown in FIG. 6A may be enhanced or expanded by adding one or more additional columns, as shown in FIG. 6B. For example, the training data set 600 may be modified with one additional column denoting Group Number to an enhanced training data set 602, which may indicate the students' group membership. This column may have a value of 1, . . . , G for G groups. In some embodiments, the training data set 600 as shown in FIG. 6A may be enhanced or expanded by adding one or more additional columns, as shown in FIG. 6C. For example, the training data set 600 may be modified with G number of additional columns denoting Group membership likelihood for each data entry (i.e., individual training example, i.e., individual student in this case). This may result in an enhanced training data set 604 as shown in FIG. 6C.

For the trained classifiers, as discussed herein elsewhere, the score distribution across different groups may vary substantially. With this enhance training data set 602 or 604, the classifier training module 124 in FIG. 1 may train the classifiers under fairness objectives simultaneously with the multiple classifier performance objectives. For example, in a situation where with G>1 groups and let φ≥0 be a group fairness coefficient of a first type, i.e., Type 1. The classifier performance and/or training objective function may be enhanced by adding the fairness objective into the multiple training objectives. For example, the classifier training module 124 in FIG. 1 may encourage the score distributions for each group to be similar:

$$MDiv\_enhanced = MDiv - BetaDist - GroupDist$$

$$where GroupDist = {\sum }_{g = 1}^{G} φ * {( MeanS ( Group g ) MeanS ( All ) )}^{2}$$

is a group score distance measure for the differences between the mean scores MeanS(Group g) conditional on the groups, and the grand mean score MeanS(All) for all students.

The trained classifiers may be trained by the classifier training module 124 to maximize MDiv_enhanced with the GroupDist term. This training process may encourage large values of MDiv, small values of BetaDist, and small values of GroupDist. To encourage small value GroupDist, the training process encourages that for the trained classifiers, the mean scores for the various groups to be close to the grand mean score and hence close to each other. In some embodiments, the coefficient φ (i.e., first group fairness coefficient) may determine the level of emphasis that is given by the classifier training to reduce the group score differences, relative to the other objectives, and the larger φ the more emphasis. This Type 1 of group fairness coefficient focuses on the mean score distribution.

In some embodiments, a Type 2 of group fairness coefficient ϕ, wherein ϕ≥0, may be introduced to further enhance fairness. This Type 2 of group fairness coefficient also considers the standard deviations of the scores:

$$MDiv\_enhanced = MDiv - BetaDist - GroupDist 2$$

$$Where GroupDist 2 = {\sum }_{g = 1}^{G} \text{} \text{[φ} * \text{} {( MeanS \text{} ( Group g ) - \text{} \text{} MeanS ( All ) )}^{2} + \text{} ϕ * {( StdS ( Group g ) - StdS ( All ) )}^{2} ]$$

is an enhanced group score distance measure that combines the differences between the mean scores conditional on the groups, and the differences between the standard deviations of scores (StdS) conditional on the groups.

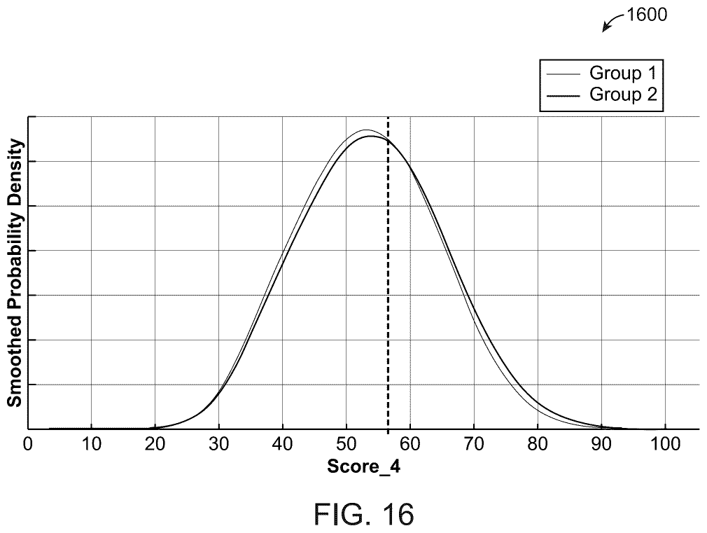

The classifier training module 124 in FIG. 1 may train the classifiers to maximize MDiv_enhanced with the GroupDist2 term. This encourages large values of MDiv, small values of BetaDist, and small values of GroupDist2, wherein the latter encouraging the trained mean scores for the various groups to be similar, as well as the standard deviations of the trained scores for the various groups to be similar. The coefficient ϕ (i.e., second group fairness coefficient) determines the level of emphasis is given by the classifier training to reduce the group score standard deviation differences, relative to the other objectives, and the larger ϕ the more emphasis. FIG. 16 illustrates the resulting score distributions for two groups for a classifier trained with a group fairness objective. As shown in FIG. 16, score distributions for two groups generated by classifier trained with MDiv_enhanced and GroupDist2 objective function with coefficient values φ=8 and ϕ=0 are presented as examples. As shown in FIG. 16, mean scores and score standard deviations are very similar for the two groups such that overall score distributions almost match. If all students whose score is below a threshold of 56 receive mentorship, then students from both groups will receive mentorship at similar rates. Due to the close similarity of the group score distributions, similar mentorship rates would also be achieved for other values of threshold. In situations with more than two groups, the score distributions of all groups can be made similar.

The classifier training module 124 may train a multitude of classifiers to maximize MDiv_enhanced for different, randomly distributed tuples of (φ, ϕ). In some embodiments, to prevent the group fairness objective to be emphasized excessively, the classifier training module 124 can generate the random distribution such that 0<φ<φₕᵢ and 0<ϕ<ϕₕᵢ. In some embodiments, the classifier training module 124 may maximize MDiv_enhanced for N3 alternative choices of the combined vector of randomly generated coefficients (α₁, . . . , α_{M}, ρ₁, . . . , ρ_{K}, φ, ϕ). Each such choice may generate a different classifier on the Pareto frontier for the multi-objective function MDiv_enhanced, resulting in a set of N3 candidate classifiers. N3 may be larger than N2 to make sure that the now higher-dimensional Pareto front of dimension M+K+2 is well covered with candidates.

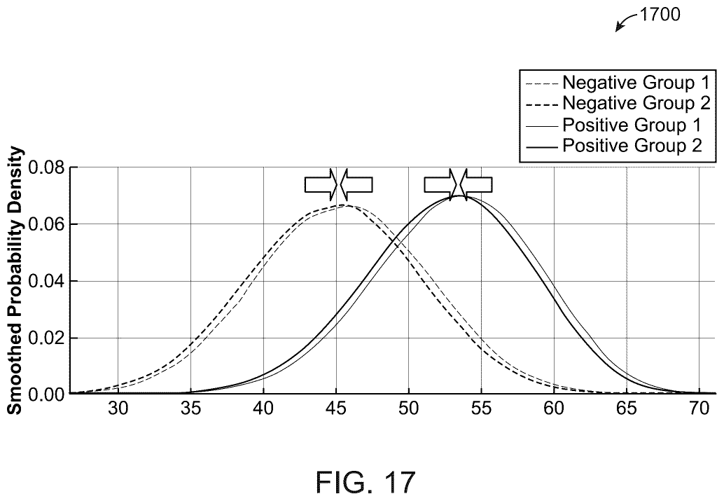

In some embodiments, the mechanisms discussed above to improve fairness in the demographic parity sense may be further generalized to improve on other notions of fairness such as equal opportunity and equalized odds. For these criteria the score distributions of the various groups may be further conditioned on a chosen binary target variable in the training data (see FIG. 17 where for simplicity only two groups are shown.). For example, the MDiv_enhanced objective function may be extended for GroupDist2 with terms for conditional means and conditional standard deviations (conditional on the target variable), wherein the corresponding coefficients (φ_{Positive}, ϕ_{Positive}, φ_{Negative}, ϕ_{Negative}) are associated with the objective function. In some embodiments, referring to the tuples of (φ, ϕ), wherein the first group fairness coefficient φ comprises a positive mean score coefficient φ_{Positive} and a negative mean score coefficient φ_{Negative}, wherein the positive mean score coefficient φ_{Positive} aids in reducing differences in mean scores for positive outcomes across different groups, and the negative mean score coefficient φ_{Negative} aids in reducing differences in mean scores for negative outcomes across different groups, wherein the second group fairness coefficient ϕ comprises a positive standard deviation coefficient ϕ_{Positive} and a negative standard deviation coefficient ϕ_{Negative}, wherein the positive standard deviation coefficient ϕ_{Positive} aids in reducing differences in standard deviations for positive outcomes across different groups, and the negative standard deviation coefficient ϕ_{Negative} aids in reducing differences in standard deviations for negative outcomes across different groups. As such, the training process performed by the classifier training module 124 is now to maximize MDiv_enhanced for N4 alternative choices of the combined vector of random coefficients (α₁, . . . , α_{M}, ρ₁, . . . , ρ_{K}, φ_{Positive}, ϕ_{Positive}, φ_{Negative}, ϕ_{Negative}). N4 can be larger than N3 to make sure that the now higher-dimensional Pareto front of dimension M+K+4 is well covered with candidates. As shown in FIG. 17, the conditional score distributions generated by a final classifier that was trained with coefficient values (φ_{Positive}, ϕ_{Positive}, φ_{Negative}, ϕ_{Negative})=(3.9, 0.2, 1.7, 0.1), demonstrate that the classifier rewards similar means and standard deviations between the groups, based on whether the outcomes are positive or negative. The vertical axis indicates the smoothed probability density of the score variable. When examining the Negatives, there is a slight variation in the score distributions between Group 1 and Group 2, with Group 2 Negatives having a marginally lower distribution than Group 1 Negatives. A comparable pattern is observed for the Positives, where the score distributions for both groups are closely aligned. In the context of mentorship assignment, if the threshold for positive students to receive mentorship is set at a score of 60, then positive students from Group 1 are at a slightly lower likelihood of receiving mentorship compared to positive students from Group 2. Considering the score distributions illustrated in FIG. 17, a decision maker might determine that a small discrepancy in the rates of mentorship assignment between the two groups of positive students is acceptable, given that both groups are afforded a roughly equivalent chance to benefit from the mentorship program.

In some embodiments, a separate set of assessment data set is constructed for training and assessing the classifiers under the additional fairness objectives. For example, similarly to the training data set 602 and 604 as shown in FIGS. 6B and 6C, the assessment data can be enhanced with one or several additional columns indicating the students' group membership, which could be a group label with values 1, . . . , G for G groups, or it could be G group membership probabilities (that add up to 1) in the case of probabilistically inferred group membership.

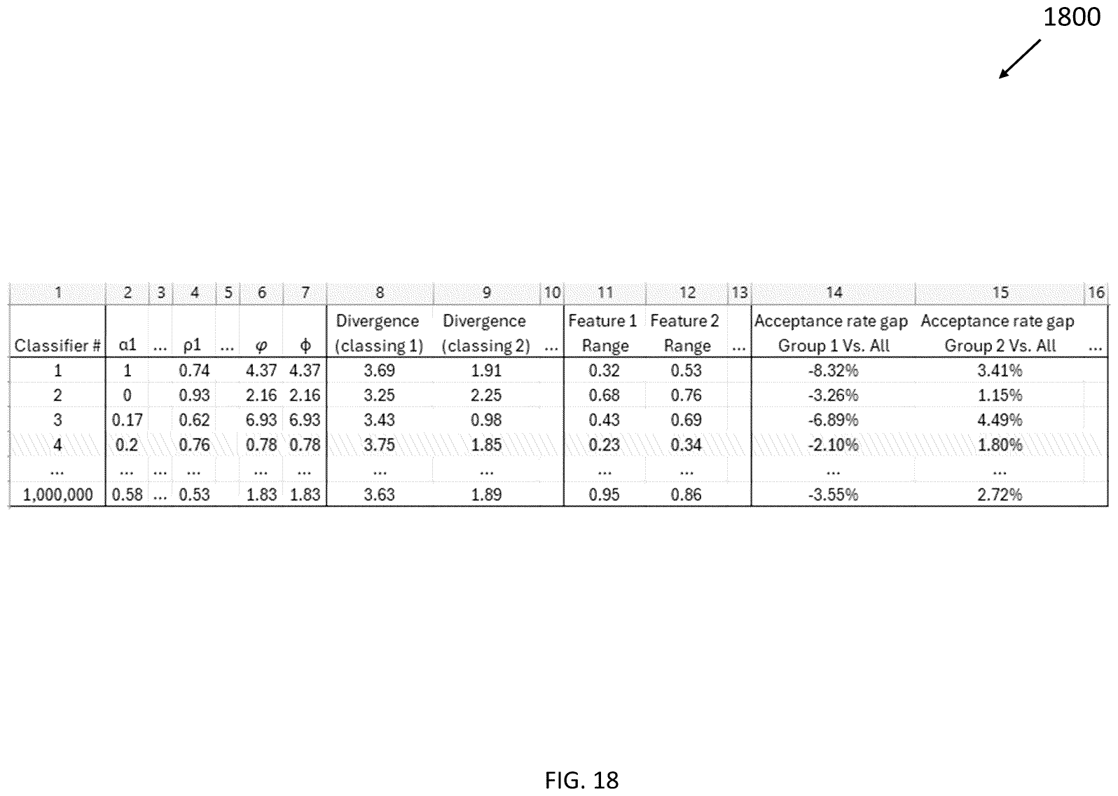

In some embodiments, with the additional training objectives, such as the feature influence objectives and the fairness objectives, the tradeoff table (e.g., as shown in FIG. 8) may be expanded. FIG. 18 illustrate an enhanced tradeoff table 1800, wherein the performances of a set of N=1,000,000 classifiers are evaluated across various objectives. As shown in FIG. 18, a high-dimensional tradeoff table including classifier performance objectives, Feature Influence objectives, and Group Fairness objectives may be generated. The tradeoff table reporting classifier performance metrics for multiple classings (i.e., columns 8-10), Feature Influence metrics for multiple features (i.e., columns 11-13), and Group Fairness metrics for multiple groups (i.e., columns 14-16). 1 million classifiers were trained and assessed, each with different randomly chosen coefficients (α₁, . . . , ρ₁, . . . , φ, ϕ), to cover the high-dimensional Pereto front spanned by a multitude of competing objectives. In some embodiments, Divergence (how well the classifier separates between positive and negative examples) is utilized as classifier performance metric. In some embodiments, feature score range (difference between maximum and minimum Feature Score value) is utilized as feature influence metric, and acceptance rate for a beneficial service (such as mentorship program admission) is utilized as group fairness metric. As shown in FIG. 18, Classifier #4 may be a possible preferred choice for a decision maker who seeks high Divergences for a multitude of classings, seeks to down-scale or up-scale the influence of a multitude of features, and seeks minimal acceptance rate gaps for a multitude of groups. Examining extensive tradeoff tables that may contain millions of rows representing numerous candidate classifiers, along with a multitude of columns for various objectives, to identify a classifier that achieves an ideal balance is an impractical task without specialized assistance. Consequently, the visual tool as shown in FIGS. 9-11 is designed for the interactive determination of a preferred tradeoff.

Example 1: A computer-implemented method for generating a classifier may include processing, by at least one processor, a training data set, wherein the training data set comprises a plurality of training examples, and wherein each of the plurality of training examples is associated with multiple class labels and a group membership label; training, by the at least one processor, a set of candidate classifiers, wherein random weights are assigned to multiple performance objectives for training the set of candidate classifiers, and wherein the multiple performance objectives correspond to the multiple class labels; assessing, by the at least one processor, each classifier of the set of candidate classifiers to generate multiple performance measurements for each of the set of candidate classifiers, wherein each of the multiple performance measurements is associated with each of the multiple performance objectives, respectively; generating, by the at least one processor, a tradeoff table presenting performances of each classifier of the set of candidate classifiers, based at least in part on the multiple performance measurements; and providing, by the at least one processor via a display, a visualization of the tradeoff table with dynamic interactive user experience to illustrate corresponding performances across different corresponding first set of performance objectives of the multiple performance objectives, wherein the dynamic interactive user experience allows a user to adjust a level of focus on a first set of the multiple performance objectives.

Example 2: The method of Example 1, wherein the method further includes training the set of candidate classifiers to maximize a randomized Multidivergence objective for each choice of the random weights assigned to the multiple performance objectives, wherein the randomized Multidivergence objective is a weighted linear combination of divergence associated with the multiple performance objectives.

Example 3: The method of Example 2, wherein the method further includes training the set of candidate classifiers to minimize a first group score distance between mean scores across different groups.

Example 4: The method of Example 3, wherein the method further includes training the set of candidate classifiers to minimize a second group score distance between standard deviations across different groups.

Example 5: The method of Example 4, further comprising adjusting a first group fairness coefficient associated with the first group score distance to balance between the performance objectives and mean score distribution across different groups; and adjusting a second group fairness coefficient associated with the second group score distance to balance between the performance objectives and standard deviation distribution across different groups.

Example 6: The method of Example 1, wherein the group membership label comprises a multi-class group membership label.

Example 7: The method of Example 1, wherein the group membership label comprises probabilistic estimates of group membership associated with the training example.

Example 8: A computer program product comprising a non-transient machine-readable medium storing instructions that, when executed by at least one programmable processor, cause the at least one programmable processor to perform operations comprising: processing a training data set, wherein the training data set comprises a plurality of training examples, and wherein each of the plurality of training examples is associated with multiple class labels and a group membership label; training a set of candidate classifiers, wherein random weights are assigned to multiple performance objectives for training the set of candidate classifiers, and wherein the multiple performance objectives correspond to the multiple class labels; assessing each classifier of the set of candidate classifiers to generate multiple performance measurements for each of the set of candidate classifiers, wherein each of the multiple performance measurements is associated with each of the multiple performance objectives, respectively; generating a tradeoff table presenting performances of each classifier of the set of candidate classifiers, based at least in part on the multiple performance measurements; and providing a visualization of the tradeoff table with dynamic interactive user experience to illustrate corresponding performances across different corresponding first set of performance objectives of the multiple performance objectives, wherein the dynamic interactive user experience allows a user to adjust a level of focus on a first set of the multiple performance objectives.

Example 9: The computer program product of Example 8, wherein the operations further comprise: training the set of candidate classifiers to maximize a randomized Multidivergence objective for each choice of the random weights assigned to the multiple performance objectives, wherein the randomized Multidivergence objective is a weighted linear combination of divergence associated with the multiple performance objectives.

Example 10: The computer program product of Example 9, wherein the operations further comprise: training the set of candidate classifiers to minimize a first group score distance between mean scores across different groups.

Example 11: The computer program product of Example 10, wherein the operations further comprise: training the set of candidate classifiers to minimize a second group score distance between standard deviations across different groups.

Example 12: The computer program product of Example 11, wherein the operations further comprise: adjusting a first group fairness coefficient associated with the first group score distance to balance between the performance objectives and mean score distribution across different groups; and adjusting a second group fairness coefficient associated with the second group score distance to balance between the performance objectives and standard deviation distribution across different groups.

Example 13: The computer program product of Example 8, wherein the group membership label comprises a multi-class group membership label.

Example 14: The computer program product of Example 8, wherein the group membership label comprises probabilistic estimates of group membership associated with the training example.

Example 15: A system comprising: a programmable processor; and a non-transient machine-readable medium storing instructions that, when executed by the processor, cause the at least one programmable processor to perform operations comprising: processing a training data set, wherein the training data set comprises a plurality of training examples, and wherein each of the plurality of training examples is associated with multiple class labels and a group membership label; training a set of candidate classifiers, wherein random weights are assigned to multiple performance objectives for training the set of candidate classifiers, and wherein the multiple performance objectives correspond to the multiple class labels; assessing each classifier of the set of candidate classifiers to generate multiple performance measurements for each of the set of candidate classifiers, wherein each of the multiple performance measurements is associated with each of the multiple performance objectives, respectively; generating a tradeoff table presenting performances of each classifier of the set of candidate classifiers, based at least in part on the multiple performance measurements; and providing a visualization of the tradeoff table with dynamic interactive user experience to illustrate corresponding performances across different corresponding first set of performance objectives of the multiple performance objectives, wherein the dynamic interactive user experience allows a user to adjust a level of focus on a first set of the multiple performance objectives.

Example 16: The system of Example 15, wherein the operations further comprise: training the set of candidate classifiers to maximize a randomized Multidivergence objective for each choice of the random weights assigned to the multiple performance objectives, wherein the randomized Multidivergence objective is a weighted linear combination of divergence associated with the multiple performance objectives.

Example 17: The system of Example 16, wherein the operations further comprise: training the set of candidate classifiers to minimize a first group score distance between mean scores across different groups.

Example 18: The system of Example 17, wherein the operations further comprise: training the set of candidate classifiers to minimize a second group score distance between standard deviations across different groups.

Example 19: The system of Example 18, wherein the operations further comprise: adjusting a first group fairness coefficient associated with the first group score distance to balance between the performance objectives and mean score distribution across different groups; and adjusting a second group fairness coefficient associated with the second group score distance to balance between the performance objectives and standard deviation distribution across different groups.

Example 20: The system of Example 15, wherein the group membership label comprises a multi-class group membership label.

Example 21: The system of Example 15, wherein the group membership label comprises probabilistic estimates of group membership associated with the training example.

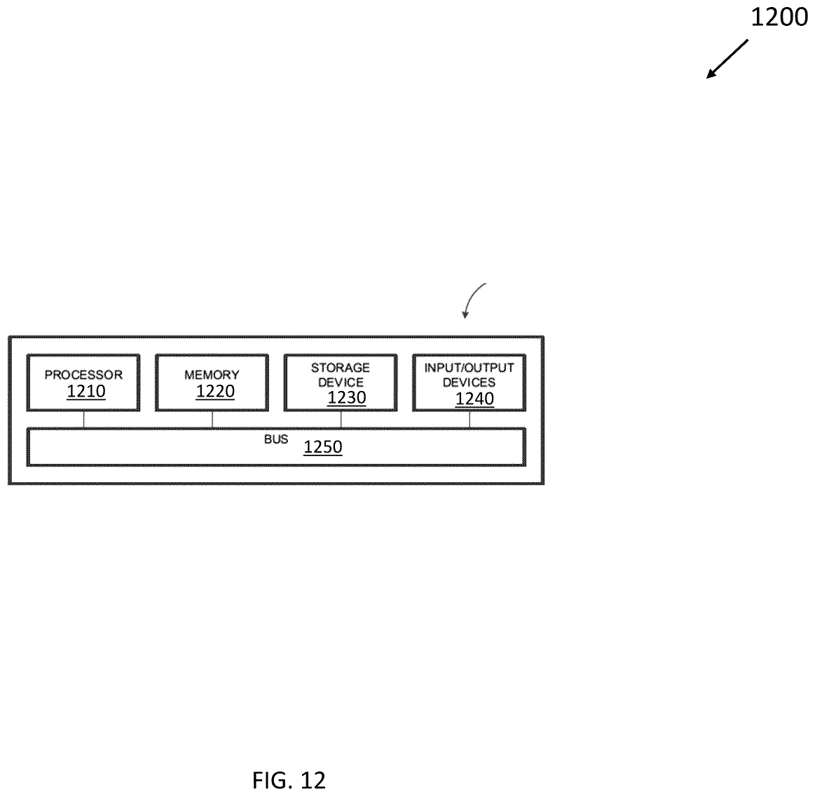

FIG. 12 depicts a block diagram illustrating a computing system 1200 consistent with implementations of the current subject matter. Referring to FIG. 1, the computing system 1200 can be used to implement the system 100, the platform 120, and/or any components therein.

As shown in FIG. 12, the computing system 1200 can include a processor 1210, a memory 1220, a storage device 1230, and input/output devices 1240. The processor 1210, the memory 1220, the storage device 1230, and the input/output devices 1240 can be interconnected via a system bus 1250. The computing system 1200 may additionally or alternatively include a graphic processing unit (GPU), such as for image processing, and/or an associated memory for the GPU. The GPU and/or the associated memory for the GPU may be interconnected via the system bus 1250 with the processor 1210, the memory 1220, the storage device 1230, and the input/output devices 1240. The memory associated with the GPU may store one or more images described herein, and the GPU may process one or more of the images described herein. The GPU may be coupled to and/or form a part of the processor 1210. The processor 1210 is capable of processing instructions for execution within the computing system 1200. Such executed instructions can implement one or more components of, for example, the system 100, the server platform 120, and/or any components therein. In some implementations of the current subject matter, the processor 1210 can be a single-threaded processor. Alternately, the processor 1210 can be a multi-threaded processor. The processor 1210 is capable of processing instructions stored in the memory 1220 and/or on the storage device 1230 to display graphical information for a user interface provided via the input/output device 1240.

The memory 1220 is a computer readable medium such as volatile or non-volatile that stores information within the computing system 1200. The memory 1220 can store data structures representing configuration object databases, for example. The storage device 1230 is capable of providing persistent storage for the computing system 1200. The storage device 1230 can be a floppy disk device, a hard disk device, an optical disk device, or a tape device, or other suitable persistent storage means. The input/output device 1240 provides input/output operations for the computing system 1200. In some implementations of the current subject matter, the input/output device 1240 includes a keyboard and/or pointing device. In various implementations, the input/output device 1240 includes a display unit for displaying graphical user interfaces.

According to some implementations of the current subject matter, the input/output device 1240 can provide input/output operations for a network device. For example, the input/output device 1240 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1240. The user interface can be generated and presented to a user by the computing system 1200 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method for generating a classifier, comprising:
processing, by at least one processor, a training data set, wherein the training data set comprises a plurality of training examples, and wherein each of the plurality of training examples is associated with multiple class labels;
training, by the at least one processor, a set of candidate classifiers, wherein random weights are assigned to multiple training objectives for training the set of candidate classifiers, and wherein the multiple training objectives corresponds to the multiple class labels;
assessing, by the at least one processor, each classifier of the set of candidate classifiers to generate multiple performance measurements for each of the set of candidate classifiers, wherein each of the multiple performance measurements is associated with each of the multiple training objectives, respectively;
generating, by the at least one processor, a tradeoff table presenting performances of each classifier of the set of candidate classifiers, based at least in part on the multiple performance measurements; and
providing, by the at least one processor via a display, a visualization of the tradeoff table with dynamic interactive user experience to illustrate corresponding performances across different corresponding objectives of the multiple training objectives, wherein the dynamic interactive user experience allows a user to adjust a level of focus on a first set of the multiple training objectives.

2. The method of claim 1, wherein the visualization of the tradeoff table dynamically presents a corresponding adjustment to a level of focus on a second set of the multiple training objectives in response to the user adjusting the level of focus on the first set of the multiple training objectives.

3. The method of claim 1, wherein the training the set of candidate classifiers further comprises: training the set of candidate classifiers to maximize a randomized Multidivergence objective for each choice of the random weights assigned to the multiple training objectives, wherein the randomized Multidivergence objective is a weighted linear combination of divergence associated with the multiple training objectives.

4. The method of claim 1, further comprising:
for a subset of the candidate classifiers, generating a set of mix-scores, wherein each of the mix-scores is a randomly weighted linear combination of customized scores generated by each of the subset of the candidate classifiers, wherein each of the subset of the candidate classifiers are trained to maximize a specific use-specific divergence related to a particular training objective of the multiple training objectives;
ranking the set of mix-scores to select a combination of weights associated with a highest ranked mix-score of the set of mix-scores; and
construct a preferred classifier using the selected combination of weights.

5. The method of claim 1, wherein the assessing each classifier of the set of candidate classifiers utilizes an assessment data set, and wherein the assessment data set comprises a plurality of evaluation examples, wherein each of the evaluation examples is associated with multiple evaluation class labels.

6. The method of claim 1, further comprising adjusting influences of one or more features on outputs of the candidate classifiers by incorporating an additional objective into the multiple training objectives,
wherein for the one or more features, the additional objective minimizes a distance between coefficients of the candidate classifiers and desired coefficients.

7. The method of claim 1, wherein training the set of candidate classifiers further comprises incorporating a fairness objective into the multiple training objectives, wherein the fairness objective minimizes classifier outcome distribution disparities across different groups.

8. A computer program product comprising a non-transient machine-readable medium storing instructions that, when executed by at least one programmable processor, cause the at least one programmable processor to perform operations comprising:
processing a training data set, wherein the training data set comprises a plurality of training examples, and wherein each of the plurality of training examples is associated with multiple class labels;
training a set of candidate classifiers, wherein random weights are assigned to multiple training objectives for training the set of candidate classifiers, and wherein the multiple training objectives corresponds to the multiple class labels;
assessing each classifier of the set of candidate classifiers to generate multiple performance measurements for each of the set of candidate classifiers, wherein each of the multiple performance measurements is associated with each of the multiple training objectives, respectively;
generating a tradeoff table presenting performances of each classifier of the set of candidate classifiers, based at least in part on the multiple performance measurements; and
providing a visualization of the tradeoff table with dynamic interactive user experience to illustrate corresponding performances across different corresponding objectives of the multiple training objectives, wherein the dynamic interactive user experience allows a user to adjust a level of focus on a first set of the multiple training objectives.

9. The computer program product of claim 8, wherein the visualization of the tradeoff table dynamically presents a corresponding adjustment to a level of focus on a second set of the multiple training objectives in response to the user adjusting the level of focus on the first set of the multiple training objectives.

10. The computer program product of claim 8, wherein the operation of training the set of candidate classifiers further comprises: training the set of candidate classifiers to maximize a randomized Multidivergence objective for each choice of the random weights assigned to the multiple training objectives, wherein the randomized Multidivergence objective is a weighted linear combination of divergence associated with the multiple training objectives.

11. The computer program product of claim 8, wherein the operations further comprise:
for a subset of the candidate classifiers, generating a set of mix-scores, wherein each of the mix-scores is a randomly weighted linear combination of customized scores generated by each of the subset of the candidate classifiers, wherein each of the subset of the candidate classifiers are trained to maximize a specific use-specific divergence related to a particular training objective of the multiple training objectives;
ranking the set of mix-scores to select a combination of weights associated with a highest ranked mix-score of the set of mix-scores; and
construct a preferred classifier using the selected combination of weights.

12. The computer program product of claim 8, wherein the assessing each classifier of the set of candidate classifiers utilizes an assessment data set, and wherein the assessment data set comprises a plurality of evaluation examples, wherein each of the evaluation examples is associated with multiple evaluation class labels.

13. The computer program product of claim 8, wherein the operations further comprise:
adjusting influences of one or more features on outputs of the candidate classifiers by incorporating an additional objective into the multiple training objectives,
wherein for the one or more features, the additional objective minimizes a distance between coefficients of the candidate classifiers and desired coefficients.

14. The computer program product of claim 8, wherein training the set of candidate classifiers further comprises incorporating a fairness objective into the multiple training objectives, wherein the fairness objective minimizes classifier outcome distribution disparities across different groups.

15. A system comprising:
a programmable processor; and
a non-transient machine-readable medium storing instructions that, when executed by the processor, cause the at least one programmable processor to perform operations comprising:
processing a training data set, wherein the training data set comprises a plurality of training examples, and wherein each of the plurality of training examples is associated with multiple class labels;
training a set of candidate classifiers, wherein random weights are assigned to multiple training objectives for training the set of candidate classifiers, and wherein the multiple training objectives corresponds to the multiple class labels;
assessing each classifier of the set of candidate classifiers to generate multiple performance measurements for each of the set of candidate classifiers, wherein each of the multiple performance measurements is associated with each of the multiple training objectives, respectively;
generating a tradeoff table presenting performances of each classifier of the set of candidate classifiers, based at least in part on the multiple performance measurements; and
providing a visualization of the tradeoff table with dynamic interactive user experience to illustrate corresponding performances across different corresponding objectives of the multiple training objectives, wherein the dynamic interactive user experience allows a user to adjust a level of focus on a first set of the multiple training objectives.

16. The system of claim 15, wherein the visualization of the tradeoff table dynamically presents a corresponding adjustment to a level of focus on a second set of the multiple training objectives in response to the user adjusting the level of focus on the first set of the multiple training objectives.

17. The system of claim 15, wherein the operation of training the set of candidate classifiers further comprises: training the set of candidate classifiers to maximize a randomized Multidivergence objective for each choice of the random weights assigned to the multiple training objectives, wherein the randomized Multidivergence objective is a weighted linear combination of divergence associated with the multiple training objectives.

18. The system of claim 15, wherein the operations further comprise:
for a subset of the candidate classifiers, generating a set of mix-scores, wherein each of the mix-scores is a randomly weighted linear combination of customized scores generated by each of the subset of the candidate classifiers, wherein each of the subset of the candidate classifiers are trained to maximize a specific use-specific divergence related to a particular training objective of the multiple training objectives;
ranking the set of mix-scores to select a combination of weights associated with a highest ranked mix-score of the set of mix-scores; and
construct a preferred classifier using the selected combination of weights.

19. The system of claim 15, wherein the assessing each classifier of the set of candidate classifiers utilizes an assessment data set, and wherein the assessment data set comprises a plurality of evaluation examples, wherein each of the evaluation examples is associated with multiple evaluation class labels.

20. The system of claim 15, wherein the operations further comprise:
adjusting influences of one or more features on outputs of the candidate classifiers by incorporating an additional objective into the multiple training objectives,
wherein for the one or more features, the additional objective minimizes a distance between coefficients of the candidate classifiers and desired coefficients.
